(19) United States
(12) Patent Application Publication
(10) Pub. No.: US 2013/0223269 A1
(43) Pub. Date: Aug. 29, 2013

(54) BASE STATION DEVICE, MOBILE STATION DEVICE, AND RADIO COMMUNICATION SYSTEM USING SAME

(71) Applicants: Shimpei To, Osaka-shi (JP); Hiromichi Tomeba, Osaka-shi (JP); Minoru Kubota, Osaka-shi (JP); Takashi Onodera, Osaka-shi (JP); Kozue Hirata, Osaka-shi (JP); Hiroshi Nakano, Osaka-shi (JP); Alvaro Ruiz Delgado, Osaka-shi (JP)

(72) Inventors: Shimpei To, Osaka-shi (JP); Hiromichi Tomeba, Osaka-shi (JP); Minoru Kubota, Osaka-shi (JP); Takashi Onodera, Osaka-shi (JP); Kozue Hirata, Osaka-shi (JP); Hiroshi Nakano, Osaka-shi (JP); Alvaro Ruiz Delgado, Osaka-shi (JP)

(73) Assignee: SHARP KABUSHIKI KAISHA, Osaka-shi, Osaka (JP)

(21) Appl. No.: 13/882,770

(22) PCT Filed: Oct. 5, 2011
(86) PCT No.: PCT/JP2011/072919

§ 371 Date: May 1, 2013

(30) Foreign Application Priority Data
Nov. 2, 2010 (JP) 2010-246391

(51) Int. Cl. H04B 7/04

(52) U.S. Cl. CPC H04B 7/0421
USPC 370/252; 370/329

(57) ABSTRACT

Provided is a radio communication system in which a base station apparatus with a plurality of transmission antennas spatially multiplexes and transmits a transmission signal addressed to a plurality of mobile station apparatuses, and in which the mobile station apparatuses receive the signal transmitted from the base station apparatus. The mobile station apparatuses select a desired precoding vector from predetermined candidates, and give the base station apparatus information identifying the selected precoding vector. The base station apparatus generates a linear filter on the basis of the information from the mobile station apparatuses, grasps multi-user interference that at least one of the mobile station apparatuses is subjected to when the generated linear filter is used, generates a new transmission signal by subtracting the multi-user interference from the transmission signal, and spatially multiplexes the transmission signal addressed to the plurality of mobile station apparatuses by multiplying the new transmission signal by the linear filter. Thus, favorable reception characteristics can be obtained while CSI feedback is performed efficiently.

### TECHNICAL FIELD

The present invention relates to a base station apparatus that performs multi user-MIMO (MU-MIMO) transmission, a mobile station apparatus, and a radio communication system using the same.

### BACKGROUND ART

As a technology for realizing high frequency-utilization efficiency and high-speed transmission so as to address the tightening of frequency resources as a result of the increase in the amounts of data communications in radio communication systems, such as cellular systems, researches on downlink MIMO (Multiple-Input Multiple-Output) transmission, in which a plurality of transmission signals (transmission streams) is spatially multiplexed by using a plurality of transmission antennas of a base station apparatus, are being actively conducted. Among others, single user-MIMO (SU-MIMO), by which a plurality of transmission signals addressed to a single mobile station apparatus having a plurality of reception antennas is spatially multiplexed and simultaneously transmitted, can greatly increase the transmission rate per mobile station apparatus. Thus, this technology is very effective when high transmission rates are required, such as for transmission of moving images.

Meanwhile, multi user-MIMO (MU-MIMO), by which transmission signals addressed to a plurality of mobile station apparatuses are spatially multiplexed and simultaneously transmitted, can perform transmission by effectively utilizing the transmission antennas on the base station end even when the number of the reception antennas provided to the individual mobile station apparatus is small. In addition, this technology provides a multi-user diversity effect by appropriately selecting the mobile station apparatuses for spatial multiplexing. Thus, MU-MIMO is gaining attention as a technology for improving the frequency utilization efficiency of a system as a whole.

In the downlink MU-MIMO transmission, because the signals addressed to the multiple mobile station apparatuses (users) are transmitted with the same resource, it is necessary to perform precoding in advance on the base station apparatus end before transmission so as to prevent interference of the reception signals in the mobile station apparatuses. The method for precoding may be roughly categorized into linear precoding by which the multiple transmission signals are multiplied by a linear weight, and non-linear precoding by which the transmission signals are multiplied by a linear weight after known interference signals are sequentially subtracted from the transmission signal. While the non-linear precoding involves complex processing compared with the linear precoding, the non-linear precoding enables removal of the interference signals by a non-linear process, so that the degree of freedom of the transmission antennas can be effectively utilized. Thus, compared with the linear precoding, the non-linear precoding provides favorable reception characteristics.

A representative example of the MU-MIMO transmission using non-linear precoding is MU-MIMO transmission using Tomlinson-Harashima precoding (THP MU-MIMO). As an example of THP MU-MIMO, a technique using QR decomposition will be described below (see Non-patent Document 1 indicated below). In not just THP MU-MIMO but downlink MU-MIMO generally, the base station apparatus first acquires information (Channel State Information: CSI) indicating the propagation path measured in each mobile station apparatus. It is assumed herein that the base station apparatus is informed of the CSI by a method by which information quantizing the propagation path itself measured in each mobile station apparatus is explicitly fed back as explicit CSI.

For example, the base station apparatus has two transmission antennas, and the CSI fed back from two mobile station apparatuses (mobile station apparatus 1 and 2), each having one reception antenna, is consolidated into a matrix form as a propagation path matrix, which is expressed by the following expression. A propagation path variation that is caused when a signal is transmitted from an antenna k of the base station apparatus to a mobile station apparatus m is hₘₖ. For example, h₁₂ denotes the propagation path variation that is caused when a signal is transmitted from the antenna 2 of the base station apparatus to the mobile station apparatus 1.

$$H = ( \begin{matrix}{h}_{11} & {h}_{12} \\ {h}_{21} & {h}_{22}\end{matrix} ) \qquad ( 1 )$$

With respect to a complex conjugate transpose matrix of the propagation path matrix, the base station apparatus that performs THP MU-MIMO transmission implements QR decomposition according to the following expression, where Q denotes a unitary matrix and R denotes an upper triangular matrix.

H^{H}=QR (2)

In the base station apparatus that performs THP MU-MIMO using QR decomposition, a transmission signal d=[d₁ d₂]^{T} is multiplied by the resultant unitary matrix Q for precoding. When such precoding is performed, a reception signal r=[r₁ r₂]^{T} in each mobile station apparatus is expressed by the following expression, in which a noise component added in the mobile station apparatus is omitted for ease of description.

$$r = HQd = {R}^{H} {Q}^{H} Qd = ( \begin{matrix}{r}_{1} & 0 \\ {r}_{2} & {r}_{3}\end{matrix} ) ( \begin{matrix}{d}_{1} \\ {d}_{2}\end{matrix} ) \qquad ( 3 )$$

From expression (3), it is seen that when precoding is performed by using the unitary matrix Q, the mobile station apparatus 1 is not subjected to multi-user interference and can receive only the desired signal. On the other hand, it is seen that the reception signal of the mobile station apparatus 2 contains the signal addressed to the mobile station apparatus 1 and that the multi-user interference is not removed. In THP MU-MIMO, a process for subtracting the multi-user interference that cannot be removed from the transmission signal by the matrix multiplication is performed in advance. It should be noted, however, that in the present example directed to the two mobile station apparatuses, the interference that the signal addressed to the mobile station apparatus 1 causes in the mobile station apparatus 2 is subtracted in advance from the signal addressed to the mobile station apparatus 2. When such subtracting process is performed, the reception signal in each mobile station apparatus is expressed by the following expression.

$$r = ( \begin{matrix}{r}_{1} & 0 \\ {r}_{2} & {r}_{3}\end{matrix} ) ( \begin{matrix}{d}_{1} \\ {d}_{2}^{′}\end{matrix} ) = ( \begin{matrix}{r}_{1} & 0 \\ {r}_{2} & {r}_{3}\end{matrix} ) ( \begin{matrix}{d}_{1} \\ {d}_{2} - \frac{{r}_{2}}{{r}_{3}} {d}_{1}\end{matrix} ) = ( \begin{matrix}{r}_{1} {d}_{1} \\ {r}_{2} {d}_{2}\end{matrix} ) \qquad ( 4 )$$

As will be seen from expression (4), by subtracting the multi-user interference that could not be removed from the transmission signal by the precoding by the unitary matrix Q alone in advance, it becomes possible for each mobile station apparatus to receive only the desired signal that does not contain the multi-user interference.

However, when multi-user interference is subtracted from the transmission signal as described above, the amplitude of the signal obtained as a result of the subtraction may be greatly increased compared with the amplitude of the original signal, resulting in an increase in transmission power. In order to avoid this problem, THP is applied whereby an appropriate vector is added to the transmission signal so that the transmission signal remains within a prescribed transmission power. The arithmetic by THP is a non-linear arithmetic, which is also referred to as a modulo arithmetic, expressed by the following expression.

$${Mod}_{M} ( x ) = x - floor ( \frac{Re ( x ) + M}{2 M} ) \times 2 M - j floor ( \frac{Im ( x ) + M}{2 M} ) \times 2 M \qquad ( 5 )$$

The input signal x (input signal is d₂ in the above example) is a complex number, j is an imaginary unit, and M is a constant of an actual number determined by the modulation system. Specifically, when the average power for the modulation symbol is normalized to 1, M=√2 for QPSK, M=4/√10 for 16QAM, and M=8/√42 for 64QAM. The floor (x) denotes a maximum integer not exceeding x.

By such arithmetic, no matter what the value of the input signal x is, the output signal Mod_{M}(x) remains within the range of [−M, M] from an origin. In this case, the vector added to the input signal by expression (5) is referred to as a perturbation vector, so that it can be said that THP (modulo arithmetic) is an arithmetic that adds an appropriate perturbation vector to each of an in-phase component and an quadrature component of the input signal. The influence of the perturbation vector thus added by the modulo arithmetic can be eliminated by performing the same modulo arithmetic for the reception signal on the reception end as that on the transmission end. Thus, in the mobile station apparatus, the modulo arithmetic is implemented and demodulation is performed after propagation path compensation is performed for the reception signal.

By using such THP (modulo arithmetic), it becomes possible to maintain the signal amplitude within a predetermined range, whereby a signal from which the interference between users is subtracted in advance can be transmitted while a prescribed transmission power is satisfied. Thus, MU-MIMO transmission in which the degree of freedom of the transmission antenna is effectively utilized can be performed, so that favorable reception characteristics can be obtained compared with MU-MIMO transmission using linear precoding.

### PRIOR-ART DOCUMENT

### Non-Patent Document

Non-patent Document 1: Aoki, et al., “Pilot Signal for MIMO Broadcast Channel based on Tomlinson-Harashima Precoding”, IEICE Communications Society Conference B-5-39, September 2009.

### SUMMARY OF THE INVENTION

### Problem to be Solved by the Invention

The method for CSI feedback includes the aforementioned method that feeds back explicit CSI, and another method referred to as “implicit CSI feedback” whereby each mobile station apparatus selects a desired precoding vector from predetermined candidates called a “codebook”, and then feeds back information identifying the selected precoding vector as CSI. The implicit CSI is not information that represents the propagation path per se but information that represents the precoding vector by which the transmission signal is multiplied in the base station apparatus. Thus, in the precoding based on such information, it is difficult to remove the multi-user interference at all times for various combinations of the mobile station apparatuses for spatial multiplexing. Accordingly, the reception characteristics are degraded compared with the precoding based on explicit CSI. However, the amount of information required for feedback can be decreased, so that efficient feedback can be performed.

In the above-described THP MU-MIMO transmission, as indicated by expression (4), it is necessary for the base station apparatus to grasp in advance the multi-user interference contained in the signal received by the mobile station apparatus and to subtract the multi-user interference from the transmission signal. However, the implicit CSI represents the precoding vector used on the transmission end and does not represent the propagation path on the reception end, so that the multi-user interference to be subtracted cannot be grasped when the implicit CSI is fed back. Thus, in a system in which implicit CSI is fed back, THP MU-MIMO transmission cannot be performed, and spatial multiplexing in which the degree of freedom of the transmission antenna is effectively utilized cannot be performed.

An object of the present invention is to obtain favorable reception characteristics while performing CSI feedback efficiently.

### Means for Solving the Problem

According to an aspect of the present invention, a radio communication system is provided in which a base station apparatus with a plurality of transmission antennas spatially multiplexes and transmits a transmission signal addressed to a plurality of mobile station apparatuses, and in which the mobile station apparatuses receive the signal transmitted from the base station apparatus. The mobile station apparatuses select a desired precoding vector from predetermined candidates, and give the base station apparatus information identifying the selected precoding vector. The base station apparatus generates a linear filter on the basis of the information from the mobile station apparatuses, grasps multi-user interference that at least one of the mobile station apparatuses is subjected to when the generated precoding vector is used, generates a new transmission signal by subtracting the multi-user interference from the transmission signal, and spatially multiplexes the transmission signal addressed to the plurality of mobile station apparatuses by multiplying the new transmission signal by the precoding vector.

Preferably, at least one of the plurality of mobile station apparatuses may give the base station apparatus information identifying a precoding vector different from the desired precoding vector.

At least one of the plurality of mobile station apparatuses may measure a coefficient representing interference that the mobile station apparatus is subjected to, and may inform the base station apparatus of the measured coefficient.

The present specification incorporates the contents described in the specification and/or drawings of Japanese Patent Application No. 2010-246391, which forms the basis of priority of the present application.

### Effect of the Invention

By using the present invention, THP MU-MIMO transmission can be performed even when implicit CSI feedback in which each mobile station apparatus selects a desired precoding vector and feeds back information identifying the selected precoding vector as CSI is performed, whereby favorable reception characteristics can be obtained while CSI feedback can be performed efficiently.

### BRIEF DESCRIPTION OF DRAWINGS

FIG. 1 is a functional block diagram of a configuration example of a base station apparatus according to a first embodiment of the present invention.

FIG. 2 is a functional block diagram of a configuration example of a precoding unit according to the present embodiment.

FIG. 3 is a functional block diagram of a configuration example of a mobile station apparatus according to the present embodiment.

FIG. 4 is a functional block diagram of a configuration example of the precoding unit according to a second embodiment of the present invention.

FIG. 5 is a functional block diagram of a configuration example of the base station apparatus according to a third embodiment of the present invention.

FIG. 6 is a functional block diagram of a configuration example of the precoding unit according to a third embodiment of the present invention.

FIG. 7 is a functional block diagram of a configuration example of the mobile station apparatus according to a third embodiment of the present invention.

### MODES FOR CARRYING OUT THE INVENTION

According to the present invention, a configuration for performing THP MU-MIMO transmission in a system in which implicit CSI is fed back from each mobile station apparatus will be described. As described above, the implicit CSI is not information that represents the propagation path per se that is observed in each mobile station apparatus but information that represents the desired precoding vector by which the transmission signal is multiplied in the base station apparatus. Thus, the multi-user interference to be subtracted from the transmission signal when performing THP MU-MIMO transmission cannot be calculated in the same way as when explicit CSI is fed back. Accordingly, the present invention describes a method for calculating the multi-user interference to be subtracted on the basis of information obtained by converting the implicit CSI that has been fed back, and a method for feeding back information representing the multi-user interference separately from the implicit CSI, and clarifies a configuration for implementing THP MU-MIMO transmission in a system in which implicit CSI is fed back.

### First Embodiment

In a first embodiment of the present invention, a configuration example will be described in which, when each mobile station apparatus selects a desired precoding vector from a predetermined codebook and feeds the precoding vector back to a base station, the base station apparatus performs precoding including a non-linear arithmetic for MU-MIMO transmission without being given information other than an index identifying the precoding vector.

According to the present embodiment, a plurality of mobile station apparatuses (reception apparatuses, which may be referred to as “mobile terminals”) having Nᵣ reception antennas are connected to a base station apparatus (which may be referred to as a “transmission apparatus”) having Nₜ transmission antennas for communication. For simplicity, however, it is assumed that the number U of the mobile station apparatuses that are spatially multiplexed in the same radio resource is two. It should be noted, however, that the number of the mobile station apparatuses that are spatially multiplexed in the same radio resource is not limited to two since spatial multiplexing can be performed for any number as long as Nₜ≧Σ^{U}ₙ₌₁Rₙ (Rₙ is referred to as a data stream number or a rank number for the mobile station apparatus n) is satisfied. While the following description assumes a situation in which only one data stream is communicated to each mobile station apparatus (Rₙ=1,1≦n≦U), it is also possible to simultaneously transmit as many data streams as the number of reception antennas that the mobile station apparatus of each user has. Also, each mobile station apparatus may have a different number of reception antennas.

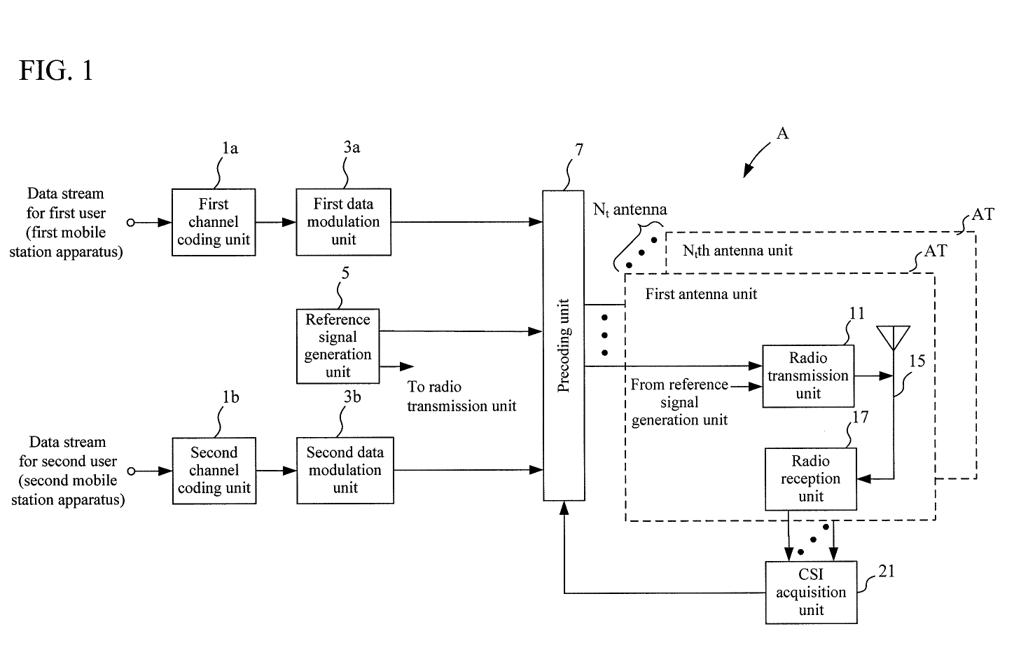

FIG. 1 shows a configuration example of the base station apparatus according to the present embodiment. As described above, according to the present embodiment, the number U of the mobile station apparatuses that are spatially multiplexed is two, and the mobile station apparatuses will be referred to as a “first user” and a “second user”.

A base station apparatus A shown in FIG. 1 includes a first channel coding unit 1a that encodes a data stream addressed to the first user (first mobile station apparatus); a second channel coding unit 1b that encodes a data stream addressed to the second user (second mobile station apparatus); a first data modulation unit 3a that modulates the signal encoded by the first channel coding unit 1a; a second data modulation unit 3b that modulates the signal encoded by the second channel coding unit 1b; a reference signal generation unit 5; a precoding unit 7; a radio transmission unit 11; an antenna 15; a radio reception unit 17; and a CSI acquisition unit 21. When the radio transmission unit 11, the antenna 15, and the radio reception unit 17 are collectively referred to as an antenna unit, the base station apparatus according to the present embodiment has Nₜ antenna units.

According to the present invention, prior to MU-MIMO transmission, it is necessary to first grasp the state of the propagation path in each mobile station apparatus (CSI: Channel State Information). For this purpose, the base station apparatus transmits a known reference signal sequence, and each mobile station apparatus performs propagation path estimation by utilizing the result of reception of the reference signal. The reference signal is generated in the reference signal generation unit and inputted to the radio transmission unit for transmission to each mobile station apparatus. The signal inputted to the radio transmission unit is converted from a digital signal to an analog signal (D/A conversion), frequency-converted to a radio-transmittable frequency band, and then transmitted from each antenna. Because it is necessary to grasp the propagation path between each transmission antenna and each reception antennas of the respective mobile station apparatuses, the transmitted reference signal is orthogonal between the antennas. The reference signal may be made orthogonal between the antennas by various methods, such as a temporally orthogonal method and a method using an orthogonal code. The base station apparatus shown in FIG. 1 is configured for single carrier transmission. However, in a system that uses multi-carrier transmission, a method by which different sub-carriers are used for the respective antennas so as to make the reference signal orthogonal in frequency domain may be used. By adopting such configurations, the base station apparatus can transmit the reference signal for propagation path estimation, thereby enabling each mobile station apparatus to perform propagation path estimation.

The configuration of the mobile station apparatuses and signal processing will be described later. As described above, propagation path estimation is performed on the basis of the reference signal transmitted from the base station apparatus, and the information (CSI) indicating the propagation path is fed back to the base station apparatus. In the base station apparatus shown in FIG. 1, the CSI that has been fed back is received by the antennas, frequency-converted to a frequency band (base band) for A/D conversion in the radio reception unit 17, and then the analog signal is converted into a digital signal. The digital signal is inputted to the CSI acquisition unit 21, and the CSI fed back from the respective mobile station apparatuses is grasped in the base station apparatus.

The CSI according to the present embodiment will be described. When the precoding vector is wₜ, according to the present embodiment, the base station apparatus and the mobile station apparatuses share a codebook describing a plurality of precoding vectors wₜ in advance, as indicated by expression (6), for example, and the mobile station apparatuses are configured to feed back an index that identifies a desired precoding vector w_{t,u} (u is a user number) to the base station apparatus as the CSI. The example indicated by expression (6) represents the codebook where the number of the transmission antennas of the base station apparatus is four, the codebook comprising 16 precoding vectors (column vector), so that four bits are required as the index for identifying each vector. Because such feedback may be said to implicitly represent the propagation path information in each mobile station apparatus, the feedback may be referred to as “implicit CSI feedback”.

$$( \begin{matrix}1 \\ 1 \\ 1 \\ 1\end{matrix} ) ( \begin{matrix}1 \\ j \\ - 1 \\ - j\end{matrix} ) ( \begin{matrix}1 \\ - 1 \\ 1 \\ - 1\end{matrix} ) ( \begin{matrix}1 \\ - j \\ - 1 \\ j\end{matrix} ) ( \begin{matrix}1 \\ \frac{1 + j}{\sqrt{2}} \\ j \\ \frac{- 1 + j}{\sqrt{2}}\end{matrix} ) ( \begin{matrix}1 \\ \frac{- 1 + j}{\sqrt{2}} \\ - j \\ \frac{1 + j}{\sqrt{2}}\end{matrix} ) ( \begin{matrix}1 \\ \frac{- 1 + j}{\sqrt{2}} \\ j \\ \frac{1 + j}{\sqrt{2}}\end{matrix} ) ( \begin{matrix}1 \\ \frac{1 + j}{\sqrt{2}} \\ - j \\ \frac{- 1 + j}{\sqrt{2}}\end{matrix} ) ( \begin{matrix}1 \\ 1 \\ - 1 \\ - 1\end{matrix} ) ( \begin{matrix}1 \\ j \\ 1 \\ j\end{matrix} ) ( \begin{matrix}1 \\ - 1 \\ - 1 \\ 1\end{matrix} ) ( \begin{matrix}1 \\ - j \\ 1 \\ - j\end{matrix} ) ( \begin{matrix}1 \\ 1 \\ 1 \\ - 1\end{matrix} ) ( \begin{matrix}1 \\ 1 \\ - 1 \\ 1\end{matrix} ) ( \begin{matrix}1 \\ - 1 \\ 1 \\ 1\end{matrix} ) ( \begin{matrix}1 \\ - 1 \\ - 1 \\ - 1\end{matrix} ) \qquad ( 6 )$$

While a specific method by which the individual user determines w_{t,u} will be described later, in one example, w_{t,u} such that the reception signal to noise power ratio (SNR) of the signal addressed to the user's station can be maximized is selected from predetermined candidates (codebook). The precoding vector that maximizes the SNR is the eigenvector (which is herein u_{u, max}) corresponding to the maximum eigenvalue (which is herein λ_{u, max}) of the eigenvectors in a matrix Hᵤ^{H}Hᵤ calculated from a propagation path matrix Hᵤ between the base station apparatus and the uth user (A^{H} represents an adjoint matrix of the matrix A). Thus, according to the present embodiment directed to transmission of rank 1, a single vector that is the closest to the eigenvector is extracted from the codebook, and the base station apparatus is informed of the corresponding index.

Upon reception of the information about the precoding vector desired by the mobile station apparatuses as the CSI, the base station apparatus then performs MU-MIMO transmission by implementing spatial multiplexing of the data signal addressed to each mobile station apparatus on the basis of the information. In the following, a method for spatial multiplexing of the data signal addressed to each mobile station apparatus will be described with reference to FIG. 1.

In the base station apparatus shown in FIG. 1, first, transmission data addressed to each user (mobile station apparatus) is inputted to the channel coding units 1a and 1b and channel-encoded therein, and then data modulation is performed in the data modulation units 3a and 3b. While the method for determining the channel coding rate applied to the transmission data addressed to each user and the data modulation method is outside the scope of the present invention, an exemplary method determines the channel coding rate and the data modulation method on the basis of control information associated with each user's reception quality that the individual user informs in advance. According to the present embodiment, the coding rate and the modulation method are determined in advance by prior exchange of control information. Outputs from the data modulation units 3a and 3b are inputted to the precoding unit 7 for performing precoding according to the present embodiment. To the precoding unit 7, there is also inputted the known reference signal generated by the stream reference signal generation unit 5. The reference signal, however, differs from the reference signal for measuring the CSI but is a reference signal for estimating the propagation path required when the reception data signal is demodulated in the mobile station apparatus. Thus, the reference signal is subjected to the same precoding in the precoding unit 7 as for the data signal. The individual reference signals are transmitted in such a manner as to be orthogonal to each other so that the reference signals can be separated in the mobile station apparatus.

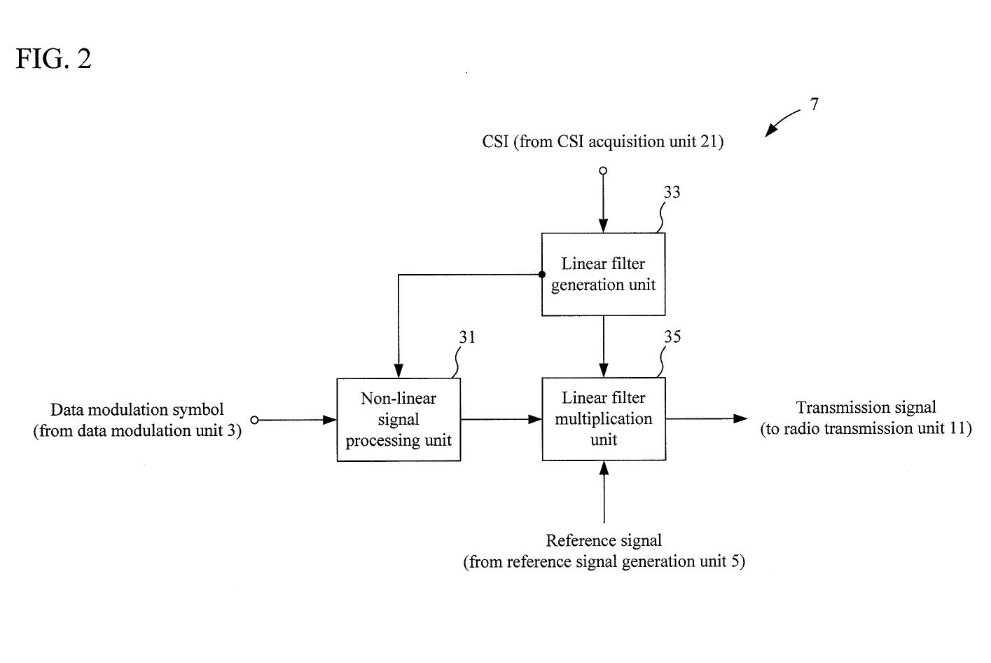

FIG. 2 shows a configuration example of the precoding unit 7 according to the present embodiment, in which the transmission symbols for the first and second users outputted from the data modulation unit 3 are d₁ and d₂, respectively, and a transmission symbol vector d is defined such that d=[d₁, d₂]^{T}. A^{T} represents a transposed matrix of the matrix A. To the linear filter generation unit 33 of the precoding unit 7, the CSI for the first and second users that have been acquired in the CSI acquisition unit 21 is inputted so as to generate a linear filter. As described above, according to the present invention, the information about the desired precoding vector of each mobile station apparatus is fed back as the CSI, so that the precoding vector w_{t, u} given by each mobile station apparatus is also inputted to the linear filter generation unit 33. When it is considered that the w_{t, u} that has been fed back and the eigenvector u_{u, max} corresponding to the maximum eigenvalue of the propagation path substantially correspond to each other, an apparent propagation path matrix H_{eff} between each user and the base station apparatus can be expressed by the following expression.

$${H}_{eff} = ( \begin{matrix}{w}_{t , 1}^{H} \\ {w}_{t , 2}^{H}\end{matrix} ) \qquad ( 7 )$$

As indicated by expression (7), the apparent propagation path matrix H_{eff} can be obtained by combining in the row direction row vectors obtained by providing the precoding vectors (herein w_{t, 1} and w_{t, 2}) informed by the respective users with complex conjugate transpose (Hermitian transposition). While the number of the simultaneously spatially multiplexed users is two, the propagation path matrix H_{eff} can be similarly shown when the number of spatial multiplexing is three or more.

Based on the propagation path matrix H_{eff} as represented above, the linear filter generation unit 33 generates a linear filter W_{eff}. The linear filter W_{eff} used in the present embodiment is a matrix that converts the propagation path matrix H_{eff} to a lower triangular matrix. The matrix can be determined by applying QR decomposition to the adjoint matrix H_{eff}^{H} of H_{eff}. Namely, when QR decomposition is performed such that H_{eff}^{H}=QR (Q is a unitary matrix, and R is an upper triangular matrix), Q is the linear filter W_{eff}, where the matrixes satisfy the following expression. Specifically, a (Nₜ×2) matrix obtained by extracting the first to the second column vectors from Q is the linear filter W_{eff}.

$$\begin{matrix}{H}_{eff} Q = {R}^{H} \\ = ( \begin{matrix}{r}_{1 , 1} & 0 & 0 & … & 0 \\ {r}_{2 , 1} & {r}_{2 , 2} & 0 & … & 0 \\ 0 & 0 & 0 & … & 0 \\ ⋮ & ⋮ & & ⋱ & \\ 0 & 0 & 0 & & 0\end{matrix} )\end{matrix} \qquad ( 8 )$$

A case is considered in which a vector W_{eff}d obtained by multiplying the transmission symbol vector by the unitary matrix Q that satisfies expression (8) as the linear filter W_{eff} is transmitted from the base station apparatus as the transmission signal vector. When the reception signal received by the mth reception antenna of the mobile station apparatus of the uth user is {r_{u, m}; u=1 to 2, m=1 to Nᵣ}, the reception signal vector rᵤ=[r_{u, 1}, . . . , r_{u, Nr}]^{T} for the uth user is given by the following expression.

rᵤ=HᵤW_{eff}d+nᵤ (9)

In expression (9), nᵤ is a noise vector. In each mobile station apparatus, the reception signal vector is multiplied by a reception filter w_{r, u} that maximizes the reception SNR of the desired signal. When transmission of rank 1 is being performed, the reception filter w_{r, u} that maximizes the reception SNR is a row vector of (Nᵣ×1) expressed by (Hᵤw_{t, u})^{H}.

Let a detection output obtained by multiplication of w_{r, u}=(Hᵤw_{t, u})^{H} be dᵤ̂. A detection output vector d̂=[d₁̂, d₂̂]^{T} combining the detection outputs for the first and second users is given by the following expression.

$$\begin{matrix}\hat{d} = ( \begin{matrix}{( {H}_{1} {w}_{t , 1} )}^{H} {r}_{1} \\ {( {H}_{2} {w}_{t , 2} )}^{H} {r}_{2}\end{matrix} ) \\ = ( \begin{matrix}{w}_{t , 1}^{H} {H}_{1}^{H} {H}_{1} \\ {w}_{t , 2}^{H} {H}_{2}^{H} {H}_{2}\end{matrix} ) {W}_{eff} d\end{matrix} \qquad ( 10 )$$

For the sake of simplicity, the noise term is omitted. When w_{t, u}=u_{u, max} is satisfied, the following expression holds.

w_{t,u}^{H}Hᵤ^{H}Hᵤ=λ_{u,max}w_{t,u}^{H} (11)

Substituting expression (11) into expression (10) yields the following expression.

$$\begin{matrix}\hat{d} = ( \begin{matrix}{λ}_{1 , max} & 0 \\ 0 & {λ}_{2 , max}\end{matrix} ) ( \begin{matrix}{w}_{t , 1}^{H} \\ {w}_{t , 2}^{H}\end{matrix} ) {W}_{eff} ( \begin{matrix}{d}_{1} \\ {d}_{2}\end{matrix} ) \\ = ( \begin{matrix}{λ}_{1 , max} & 0 \\ 0 & {λ}_{2 , max}\end{matrix} ) ( \begin{matrix}{r}_{1 , 1} & 0 \\ {r}_{2 , 1} & {r}_{2 , 2}\end{matrix} ) ( \begin{matrix}{d}_{1} \\ {d}_{2}\end{matrix} )\end{matrix} \qquad ( 12 )$$

It is seen from expression (12) that, when the linear filter W_{eff} obtained by applying QR decomposition to the adjoint matrix H_{eff}^{H} of H_{eff} is used, the first user can receive only the signal addressed thereto while in the reception signal for the second user, the signal addressed to the first user is received as interference. Thus, in the precoding unit 7, the interference signal observed by the second user is subtracted in the non-linear signal processing unit 31 in advance.

The signal processing in the non-linear signal processing unit 31 will be described. To the non-linear signal processing unit 31, a data modulation symbol d inputted to the precoding unit 7 and the H_{eff} and W_{eff} outputted from the linear filter generation unit 33 are inputted. In the non-linear signal processing unit 31, signal processing for subtracting the interference signal observed in the mobile station apparatus of the second user in advance is performed. Specifically, a transmission signal d₂ addressed to the second user is subjected to signal processing according to the following expression, and a transmission signal x₂ addressed to the second user is newly calculated.

$${x}_{2} = {d}_{2} - \frac{{r}_{2 , 1}}{{r}_{2 , 2}} {d}_{1} \qquad ( 13 )$$

By transmitting the signal x₂ expressed by expression (13) as the transmission signal addressed to the second user instead of d₂, the second user can receive only the desired signal. By performing such an interference suppressing process prior to multiplication of the linear filter W_{eff}, transmission such that the second user is also spared of interference can be performed. However, depending on the state of the propagation path information H_{eff}, the magnitude of x₂ may be far greater than d₂, resulting in a need for excessive transmission power. Thus, according to the present embodiment, x₂ is subjected to non-linear signal processing referred to as “modulo arithmetic”.

The modulo arithmetic Mod_{M}(x) is operated to cause an output with respect to a certain input x to be greater than −M and less than M, where M is referred to as a modulo width which is set depending on the modulation system and the like of the inputted signal. For example, when a QPSK modulation signal is inputted, M=sqrt(2); for 16QAM, M=4/√10; and for 64QAM, M=8/√42. When the signal x₂ is subjected to the modulo arithmetic, the output is given by the following expression, where floor(x) represents a maximum integer not exceeding x.

$${Mod}_{M} ( {x}_{2} ) = {x}_{2} - floor ( \frac{Re ( {x}_{2} ) + M}{2 M} ) \times 2 M - j floor ( \frac{Im ( {x}_{2} ) + M}{2 M} ) \times 2 M \qquad ( 14 )$$

The modulo arithmetic expressed by expression (14) may be rewritten as the following expression.

$$\begin{matrix}{Mod}_{M} ( {x}_{2} ) = {x}_{2} + 2 Mz \\ = {d}_{2} - \frac{{r}_{2 , 1}}{{r}_{2 , 2}} {d}_{1} + 2 Mz\end{matrix} \qquad ( 15 )$$

In the above expression, z is a complex number with both the real part and the imaginary part integers, and is selected such that the real part and the imaginary part in the right-hand side of expression (15) are greater than −M and less than M. 2Mz is a complex number referred to as a perturbation vector in the modulo arithmetic, with an in-phase component and a quadrature component each having a value which is an integer multiple of the modulo width M. From expression (15), it can be said that the modulo arithmetic is an arithmetic that adds the perturbation vector to the input signal. By adding the perturbation vector of an appropriate magnitude to the input signal x₂, the magnitude of Mod_{M}(x₂) can be made not more than a predetermined magnitude at all times regardless of the state of the propagation path information H_{eff}. The thus calculated x₂ (a value also including the modulo arithmetic; Mod_{M}(x₂) to be precise) is outputted from the non-linear signal processing unit 31 as the transmission symbol addressed to the second user. With regard to the transmission symbol addressed to the first user, there is no interference signal to be subtracted, so that no particular signal processing is performed in the non-linear signal processing unit 31, and the transmission symbol is outputted as is.

The output from the non-linear signal processing unit 31 is inputted to the linear filter multiplication unit 35, in which the linear filter W_{eff} inputted from the linear filter generation unit 33 is multiplied to perform precoding. To the linear filter multiplication unit 35, the reference signal from the reference signal generation unit 5 is also inputted and multiplied by the same linear filter W_{eff} by which the data signal is multiplied, as described above, thereby performing precoding. The thus precoded data modulation symbol and reference signal are temporally multiplexed and then outputted to the radio transmission unit 11 as the transmission signal.

Referring back to FIG. 1, the output from the precoding unit 7 is inputted to the radio transmission unit 11 for each transmission antenna. The signal inputted to the radio transmission unit 11 is converted from the digital signal to an analog signal (D/A conversion), frequency-converted to a radio-transmittable frequency band, and then transmitted via the respective antennas 15.

In the above configuration of the base station apparatus, MU-MIMO transmission can be performed by implementing precoding including a non-linear arithmetic even when the information that is fed back is the information about the desired precoding vector and not the information about the propagation path per se in each mobile station apparatus. It is known that precoding including a non-linear arithmetic provides favorable performances compared with precoding consisting of a linear arithmetic. Thus, by performing the non-linear precoding in the configuration according to the present embodiment, it can be expected that favorable performances will be obtained.

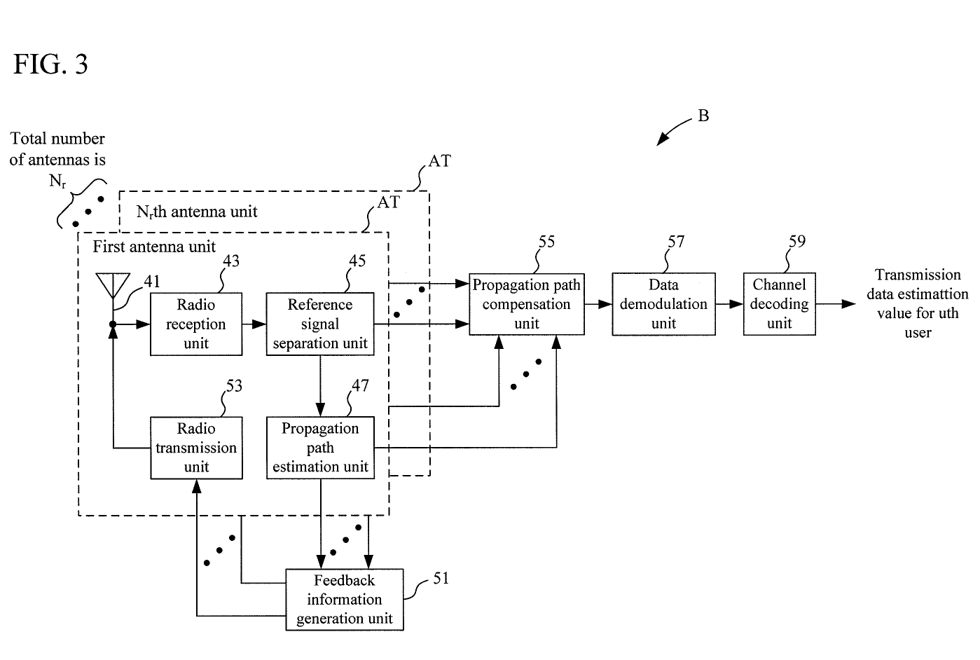

FIG. 3 shows a configuration of the mobile station apparatus according to the present embodiment. As shown in FIG. 3, a mobile station apparatus B is provided with an antenna 41; a radio reception unit 43; a reference signal separating unit 45; a propagation path estimation unit 47; a feedback information generation unit 51; a radio transmission unit 53; a propagation path compensation unit 55; a data demodulation unit 57; and a channel decoding unit 59.

In the mobile station apparatus B, the signal received by each reception antenna 41 is inputted to the corresponding radio reception unit 43, converted into a signal of a base band, and then converted into a digital signal by A/D conversion. The signal is then inputted to the reference signal separating unit 45. In the reference signal separating unit 45, the reception signal is separated into the data signal and the reference signal. The data signal is inputted to the propagation path compensation unit 55, and the reference signal is inputted to the propagation path estimation unit 47. It should be noted, however, that the reference signal transmitted from the base station apparatus may not be precoded and only the reference signal may be transmitted when the CSI is measured. In such a case, the input to the reference signal separating unit 45 is directly outputted to the propagation path estimation unit 47.

In the propagation path estimation unit 47, propagation path estimation is performed by using the received reference signal and the known reference signal used in the base station apparatus. However, when the propagation path estimation is performed by using the reference signal that is not precoded for CSI measurement, the mobile station apparatus of the uth user may estimate the propagation path matrix Hᵤ representing the propagation path between each transmission antenna of the base station apparatus and the reception antenna of the mobile station apparatus. The propagation path matrix Hᵤ estimated by using the reference signal for CSI measurement is inputted to the feedback information generation unit 51. In the feedback information generation unit 51, on the basis of the inputted propagation path matrix Hᵤ, the desirable precoding vector w_{t, u} for the station is selected from the given codebook and the corresponding index is outputted as the information that the base station apparatus is given. According to the present embodiment, which assumes the transmission of rank 1, the base station apparatus is informed of w_{t, u} such that ∥Hᵤ×w_{t, u}∥² is maximized (∥a∥ represents a norm arithmetic for the vector a). In other words, when the only mobile station apparatus that is communicating with the base station apparatus is the uth user, the base station apparatus is informed of a precoding vector such that the reception signal to noise power ratio (SNR) of the uth user can be maximized.

As noted with reference to the configuration of the base station apparatus, it is known that the linear filter w_{t, u} that maximizes ∥Hᵤ×w_{t, u}∥² under the constraint condition of a predetermined transmission power becomes an eigenvector corresponding to the maximum eigenvalue of matrix (Hᵤ^{H}Hᵤ). According to the present embodiment, the base station apparatus is informed of the index for a vector that is the closest to the above condition. However, the information that is actually fed back to the base station apparatus is not limited to the index for the precoding vector, and the base station apparatus may be directly given information about w_{t, u} that has been quantized into information of a finite bit length. The feedback information about the CSI thus generated in the feedback information generation unit 51 is transmitted from transmission antenna 41 via the radio transmission unit 53 to the base station apparatus.

On the other hand, in propagation path estimation in which the reference signal that has been subjected to the same precoding as that for the data signal is used for data signal demodulation, an equivalent propagation path Hᵤ×w_{t,u} obtained by multiplying the actual propagation path by the linear filter W_{eff} used at the time of transmission is estimated. The estimated equivalent propagation path is inputted to the propagation path compensation unit 55 and used for propagation path compensation for the data signal inputted from the reference signal separating unit 45 to the propagation path compensation unit 55. The propagation path compensation in the propagation path compensation unit 55 may be implemented by several methods. For example, a method calculates a reception filter according to MMSE criterion on the basis of the inputted equivalent propagation path and multiplies the data signal by the reception filter. Alternatively, on the basis of the w_{t, u} of which the base station apparatus has been informed and the propagation path matrix Hᵤ that has been estimated previously, (Hᵤ×w_{t, u})^{H} may be calculated as the reception filter and the data signal may be multiplied thereby. In this case, the reception SNR can be maximized.

By such processes, the influence of variation that the reception data signal is subjected to in the propagation path can be compensated. Further, in the propagation path compensation unit 55, in order to remove the perturbation vector added by the base station apparatus, a modulo arithmetic is performed on the data signal after the propagation path compensation. The modulo arithmetic is the same arithmetic as the arithmetic implemented in the base station apparatus and may be represented by expression (14) or expression (15). By applying on the reception end the same arithmetic as the modulo arithmetic implemented on the transmission end, a desired signal from which the influence of the perturbation vector is removed can be obtained. It should be noted, however, that in the base station apparatus according to the present embodiment, while the modulo arithmetic is required in the propagation path compensation unit for the second user because the modulo arithmetic is performed for the signal addressed to the second user, there is no need to perform the modulo arithmetic in the propagation path compensation unit for the first user because the modulo arithmetic is not performed for the signal addressed to the first user.

The data signal that has been thus subjected to the compensation for propagation path variation and the compensation for the perturbation vector is demodulated in the data demodulation unit and decoded in the channel decoding unit, whereby the desired data transmitted from the base station apparatus is detected.

By adopting the above configuration of the mobile station apparatus, a desired precoding vector can be selected from the predetermined codebook and then fed back to the base station apparatus, the data signal that has been subjected to the precoding including non-linear arithmetic can be received in the base station apparatus, and the reception signal can be correctly demodulated and decoded.

While the present embodiment has been described with reference to the example in which single carrier transmission is performed, the transmission system (or an access system) is not limited to single carrier transmission, and other transmission systems may be used. For example, it is possible to apply the present embodiment to the orthogonal frequency division multiplex access (OFDMA) system adopted for LTE downlink transmission. In this case, precoding may be applied on a sub-carrier basis, or precoding may be applied for each resource block bundling a plurality of sub-carriers. Similarly, it is also possible to apply the present embodiment to an access system that uses a plurality of frequency channels on a single carrier basis (such as the single carrier frequency division multiplex access (SC-FDMA) system), where precoding may be applied on a frequency component basis, or the same precoding may be performed across the entire frequency band so as to avoid transmission power emphasis.

While according to the present embodiment the modulo arithmetic is performed after the interference signal is subtracted from the transmission signal for the user for which multi-user interference is caused (second user), the modulo arithmetic may not be performed when the interference signal to be subtracted is small to a degree. Thus, the modulo arithmetic may be turned on or off depending on the magnitude (power) of the interference signal to be subtracted. When the modulo arithmetic is not performed in the base station apparatus, there is no need to perform the modulo arithmetic in the mobile station apparatus. Further, as noted above, the number of the users that are spatially multiplexed is not limited to two and may be three or more. In such cases, the modulo arithmetic may be performed only for the transmission signal addressed to the third user, for example.

According to the foregoing embodiment, users that feed back implicit CSI can be spatially multiplexd at high quality.

### Second Embodiment

The first embodiment described the configuration in which the complex conjugate transpose of the precoding vector fed back as implicit CSI is determined, and THP MU-MIMO transmission is performed by calculating the new precoding vector and the multi-user interference to be subtracted on the basis of the propagation path matrix configured from the vector. According to this method, when the complex conjugate transpose of the precoding vector that has been fed back is very similar to the actual propagation path, transmission can be performed by efficiently removing the multi-user interference as in the case of THP MU-MIMO transmission based on explicit CSI, and thereby favorable reception characteristics can be obtained.

However, the situation in which the complex conjugate transpose of the precoding vector that has been fed back is very close to the actual propagation path is not very common, and when there is an error therebetween, the multi-user interference cannot be appropriately removed, whereby the reception performances degrade.

Thus, according to the present embodiment, each mobile station apparatus feeds back not only the desired precoding vector that the apparatus desires to be applied to the transmission signal addressed thereto as the implicit CSI, but also a precoding vector that the apparatus wishes to be applied to the transmission signal addressed to the mobile station apparatus as a spatial multiplexing counterpart. Further, a coefficient that represents the multi-user interference that is observed when such precoding vectors are used is calculated, and a coefficient representing the calculated multi-user interference is also fed back to the base station apparatus. By these processes, the multi-user interference to be subtracted can be highly accurately grasped in the base station apparatus, whereby THP MU-MIMO transmission can be performed and favorable reception performances can be obtained.

Specifically, as in the first embodiment, each mobile station apparatus initially selects a desired precoding vector from a predetermined codebook. According to the present embodiment, an example in which two mobile station apparatuses (mobile station apparatus 1 and 2) each with a single reception antenna are spatially multiplexed by THP MU-MIMO will be described. The base station apparatus has four transmission antennas (Nₜ=4). The codebook used is not particularly limited as long as it is predetermined between the transmission and reception ends. For example, the codebook according to expression (6) is used.

When the propagation path observed in the mobile station apparatus u is Hᵤ and the desirable precoding vector for the station is w_{t, u}, each mobile station apparatus selects from the given codebook w_{t, u} that maximizes ∥Hᵤ×w_{t, u}∥² (∥a∥ represents a norm arithmetic of the vector a), as in the first embodiment. In other words, as noted above, when the only mobile station apparatus communicating with the base station apparatus is the uth user, a precoding vector that maximizes the reception signal to noise power ratio (SNR) of the uth user is selected.

Next, each mobile station apparatus selects a precoding vector desired to be applied to the signal addressed to the mobile station apparatus that is a spatially multiplexed counterpart in the same resource. In other words, for example, the mobile station apparatus 1 selects a precoding vector that minimizes the influence (multi-user interference) on the signal received by the mobile station apparatus 1 when the precoding vector used for precoding of the transmission signal addressed to the mobile station apparatus 2. Similarly, the mobile station apparatus 2 selects a precoding vector that minimizes the influence on the mobile station apparatus. Such precoding vector will be hereafter referred to as a “companion precoding vector” and represented by w_{c, u}.

According to the present embodiment, w_{c, 1} represents the companion precoding vector selected by the mobile station apparatus 1, and w_{c, 2} represents the companion precoding vector selected by the mobile station apparatus 2. For the companion precoding vector in the mobile station apparatus u, w_{c, u} that minimizes ∥Hᵤ×w_{c, u}∥² may be selected from the given codebook. In other words, conversely from the selection of the desired precoding vector w_{t, u}, a precoding vector that minimizes the reception signal to noise power ratio (SNR) for the uth user is selected. The companion precoding vector and the desired precoding vector are assumed to be selected from the common codebook.

After the companion precoding vector is selected, each mobile station apparatus calculates a coefficient that represents the multi-user interference that the station is subjected to. The “coefficient representing the multi-user interference” represents the multi-user interference component to be subtracted in advance from the transmission signal addressed to one station when the signal addressed to the one station is subjected to precoding by using the desired precoding vector and when the signal addressed to the mobile station apparatus which is spatially multiplexed in the same resource as the one station is subjected to precoding by using the companion precoding vector. The coefficient can be determined by (Hᵤ×w_{c, u}/(Hᵤ×w_{t, u}).

However, in order for the value or vector calculated by such arithmetics to be handled as the coefficient that represents the multi-user interference, at least one of w_{t, 1}=w_{c, 2} or w_{t, 2}=w_{c, 1} needs to be satisfied. This is because Hᵤ×w_{c, u} represents the coefficient of multi-user interference only when the desired precoding vector used for the signal addressed to the mobile station apparatus that is spatially multiplexed in the same resource and that is different from the one station corresponds to the companion precoding vector selected by the one station, and because when the multi-user interference is to be subtracted in advance from the transmission signal, it is necessary to use the result of dividing Hᵤ×w_{c, u} by the equivalent propagation path Hᵤ×w_{t, u} of the transmission signal addressed to the one station. Thus, it is necessary to select in the base station apparatus a plurality of mobile station apparatuses that satisfy such relationship, and spatially multiplex the signals addressed to the selected mobile station apparatuses.

Thus, the mobile station apparatus u calculates w_{t, u}, w_{c, u}, and (Hᵤ×w_{c, u}/(Hᵤ×w_{t, u}), and feeds them back to the base station apparatus. The base station apparatus performs precoding for removing the multi-user interference on the basis of the information that has been fed back. The base station apparatus according to the present embodiment uses the w_{t, u} fed back from each mobile station apparatus as the precoding vector as is, and uses [w_{t, 1} w_{t, 2}] as a linear filter. Then, the transmission signal is multiplied by the generated linear filter so as to perform precoding. When both w_{t, 1}=w_{c, 2} and w_{t, 2}=w_{c, 1} are satisfied with respect to the two mobile station apparatuses of interest, the reception signal of each mobile station apparatus when the above precoding is performed in the base station apparatus is represented by the following expression, where the transmission symbol and reception symbol for the mobile station apparatus 1 are d₁ and r₁, respectively, and the transmission symbol and reception symbol for the mobile station apparatus 2 are d₂ and r₂, respectively.

$$\begin{matrix}( \begin{matrix}{r}_{1} \\ {r}_{2}\end{matrix} ) = ( \begin{matrix}{H}_{1} \\ {H}_{2}\end{matrix} ) ( {w}_{t , 1} {w}_{t , 2} ) ( \begin{matrix}{d}_{1} \\ {d}_{2}\end{matrix} ) \\ = ( \begin{matrix}{H}_{1} {w}_{t , 1} & {H}_{1} {w}_{t , 2} \\ {H}_{2} {w}_{t , 1} & {H}_{2} {w}_{t , 2}\end{matrix} ) ( \begin{matrix}{d}_{1} \\ {d}_{2}\end{matrix} ) \\ = ( \begin{matrix}{H}_{1} {w}_{t , 1} & {H}_{1} {w}_{c , 1} \\ {H}_{2} {w}_{c , 2} & {H}_{2} {w}_{t , 2}\end{matrix} ) ( \begin{matrix}{d}_{1} \\ {d}_{2}\end{matrix} )\end{matrix} \qquad ( 16 )$$

On the right-hand side of expression (16), the matrix by which the data symbol vectors are multiplied is the equivalent propagation path in which the actual propagation path and precoding are considered, the off-diagonal components representing the multi-user interference coefficients. In this case, the multi-user interference included in the reception signal for the mobile station apparatus 1 is H₁w_{c, 1}d₂, and the multi-user interference included in the reception signal for the mobile station apparatus 2 is H₂w_{c, 2}d₁. It is thought that by subtracting such multi-user interference from the transmission signal in advance, the multi-user interference included in the reception signal for the mobile station apparatuses can be removed. However, in order to transmit a signal such that the multi-user interference can be removed upon reception by the mobile station apparatus, it is necessary to perform the subtracting by taking into consideration the precoding to which the desired transmission signal is subjected and the propagation path via which the transmission signal with the desired precoding is transmitted. Thus, the signal representing the multi-user interference that is actually subtracted from the transmission signal is a signal obtained by multiplying a coefficient expressed by (Hᵤ×w_{c, u})/(Hᵤ×w_{t, u}) by the transmission signal for the counterpart mobile station apparatus. The coefficient is fed back from each mobile station apparatus and can be easily grasped in the base station.

In the base station apparatus, such multi-user interference is subtracted from the transmission signal in advance. This subtracting process can be performed only for the transmission signal for one or the other of the mobile station apparatuses. Thus, it is necessary to determine the transmission signal addressed to which mobile station apparatus is to be subjected to the interference subtracting process. In the present example, of the interference coefficients that have been fed back, the one with the greater absolute value is subtracted. For example, when the interference that the signal addressed to the mobile station apparatus 2 has on the reception signal for the mobile station apparatus 1 is to be subtracted in advance, a transmission signal x₁ addressed to the mobile station apparatus 1 is newly calculated by the following expression, where the coefficient by which d₂ is multiplied is the interference coefficient fed back from the mobile station apparatus 1.

$${x}_{1} = {d}_{1} - \frac{{H}_{1} {w}_{c , 1}}{{H}_{1} {w}_{t , 1}} {d}_{2} \qquad ( 17 )$$

Conversely, when the interference that the signal addressed to the mobile station apparatus 1 causes in the reception signal for the mobile station apparatus 2 is to be subtracted in advance, a transmission signal x₂ for the mobile station apparatus 2 is newly calculated by the following expression, where the coefficient by which d₁ is multiplied is the interference coefficient fed back from the mobile station apparatus 2.

$${x}_{2} = {d}_{2} - \frac{{H}_{2} {w}_{c , 2}}{{H}_{2} {w}_{t , 2}} {d}_{1} \qquad ( 18 )$$

Thus, by transmitting the new transmission signal [x₁ d₂]^{T} or [d₁ x₂]^{T} obtained by subtracting the multi-user interference from the transmission signal in advance, the multi-user interference that one or the other mobile station apparatus is subjected to can be removed, whereby the reception performances can be improved. It should be noted, however, that, as mentioned with reference to the first embodiment, when the subtracting process according to expression (17) or expression (18) is performed, excessive transmission power may be required. In order to avoid this, as in the first embodiment, the modulo arithmetic expressed by expression (14) may be applied to the transmission signal from which the interference has been subtracted.

The base station apparatus according to the present embodiment described above can be realized with the same configuration as the configuration of the base station apparatus shown in FIG. 1. However, according to the present embodiment, the mobile station apparatus u feeds back not only the index indicating the desired precoding vector but also the index indicating the companion precoding vector and, when the precoding vectors are used, the coefficient (Hᵤ×w_{c, u})/(Hᵤ×w_{t, u}) indicating the multi-user interference to be subtracted from the transmission signal in advance. Thus, such information is acquired in the CSI acquisition unit of the base station apparatus.

The base station apparatus, after acquiring the CSI fed back from each of a number of mobile station apparatuses in the cell, selects two preferable mobile station apparatuses from the plurality of mobile station apparatuses, and performs MU-MIMO transmission by precoding the signals addressed to the selected mobile station apparatuses. Regarding the criterion for selecting the two mobile station apparatuses (paired mobile station apparatuses) for the MU-MIMO transmission, first, it is indispensable that the desired precoding vectors for the mobile station apparatuses do not overlap. Further, as described above, according to the present embodiment, the two mobile station apparatuses that are selected are such that the desired precoding vector for each is the companion precoding vector for the counterpart (both w_{t, 1}=w_{c, 2} and w_{t, 2}=w_{c, 1} are satisfied). However, this is not indispensable; it is sufficient if the two mobile station apparatuses such that at least the desired precoding vector for one is the companion precoding vector for the counterpart are selected.

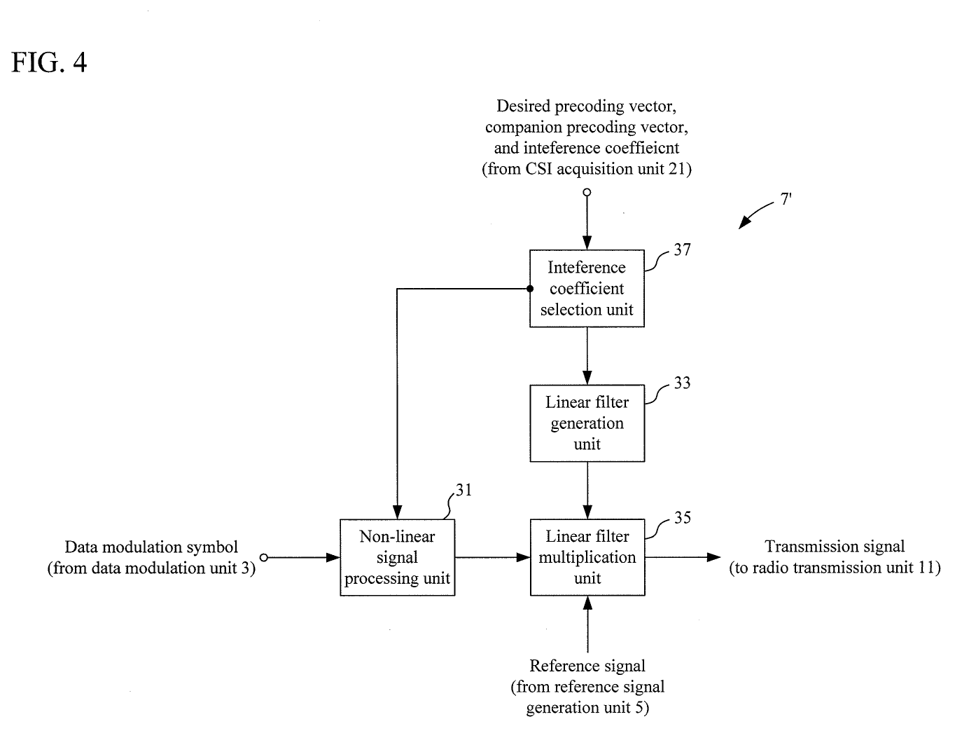

The signals addressed to the two mobile station apparatuses thus selected are precoded in the precoding unit shown in FIG. 1. The precoding unit according to the present embodiment may be configured as shown in FIG. 4. A precoding unit 7′ shown in FIG. 4 is based on the configuration of FIG. 2 to which an interference coefficient selection unit 37 is added. To the interference coefficient selection unit 37, the CSI acquisition unit 21 inputs the desired precoding vectors fed back from the spatially multiplexed two mobile station apparatuses, the companion precoding vectors, and the coefficient indicating the multi-user interference to be subtracted. In the interference coefficient selection unit 37, the absolute value of the inputted interference coefficient is calculated, and it is decided to subtract the multi-user interference from the transmission signal addressed to the mobile station apparatus that has fed back the interference coefficient of a greater value. The interference coefficient selection unit 37 then outputs information indicating the mobile station apparatus for which the multi-user interference is to be subtracted and a coefficient indicating the multi-user interference to be subtracted from the transmission signal addressed to the mobile station apparatus to the non-linear signal processing unit The interference coefficient selection unit 37 also outputs the desired precoding vector in each mobile station apparatus to the linear filter generation unit 33.

In the linear filter generation unit 33 shown in FIG. 4, a linear filter is generated on the basis of the desired precoding vector that has been inputted. It should be noted that according to the present embodiment, as noted above, the desired precoding vector fed back from each mobile station apparatus is used as is, and the linear filter W_{eff} is W_{eff}=[w_{t, 1} w_{t, 2}]. The linear filter generation unit 33 outputs the W_{eff} to the linear filter multiplication unit 35.

In the non-linear signal processing unit 31, first, data signal/multi-user interference subtraction is performed, as according to the first embodiment. In other words, the arithmetic according to expression (17) or expression (18) is performed. By the subtracting process, the multi-user interference that one of the mobile station apparatuses is subjected to can be removed. However, as a result of the subtracting process, the signal amplitude may be increased and excessive transmission power may be required. Thus, as in the first embodiment, in the non-linear signal processing unit 31, the transmission signal for which the interference subtraction has been performed is subjected to a non-linear signal processing, referred to as a modulo arithmetic, according to expression (14). The signals addressed to the two mobile station apparatuses are inputted from the non-linear signal processing unit 31 to the linear filter multiplication unit 35, multiplied by W_{eff} therein, and then outputted from the precoding unit 7′.

The transmission signals thus outputted from the precoding unit 7′ are transmitted from the transmission antennas via the radio transmission unit 11, as in the first embodiment. By adopting the configuration of the base station apparatus as described above, when each mobile station apparatus feeds back not only the index indicating the desired precoding vector but also the index indicating the companion precoding vector and, when the precoding vectors are used, a coefficient indicating the multi-user interference to be subtracted from the transmission signal in advance, the multi-user interference can be subtracted and the precoding including a non-linear arithmetic can be appropriately performed.

The mobile station apparatus according to the present embodiment can be realized with the same configuration as the configuration of the mobile station apparatus shown in FIG. 3. It should be noted, however, that, as described above, it is necessary to feed back the index indicating the desired precoding vector, the index indicating the companion precoding vector, and the coefficient indicating the multi-user interference to be subtracted from the transmission signal in advance, and such information are generated in the feedback information generation unit 51. Among others, the desired precoding vector and the companion precoding vector are obtained by selecting from the common codebook the vector that maximizes ∥Hᵤ×w_{t, u}∥² and the vector that minimizes ∥Hᵤ×w_{c, u}∥², respectively. The coefficient indicating the multi-user interference to be subtracted is obtained by calculating (Hᵤ×w_{c, u})/(Hᵤ×w_{t, u}) by using the desired precoding vector and the companion precoding vector that have been previously selected. The three items of information thus obtained in the feedback information generation unit 51 are transmitted from the transmission antenna via the radio transmission unit and fed back to the base station apparatus.

The respective mobile station apparatuses receive signals that are precoded in the base station apparatus on the basis of the information that has been fed back. This process is identical to the corresponding process in the first embodiment and therefore the description of the process is omitted herein. However, the modulo arithmetic in the propagation path compensation unit 55 may be performed only in the mobile station apparatus that receives the signal that has been subjected to the modulo arithmetic in the base station apparatus (i.e., the signal for which multi-user interference subtraction has been performed).

By adopting the above configuration, the mobile station apparatuses can feed back the index indicating the desired precoding vector, the index indicating the companion precoding vector, and the coefficient indicating the multi-user interference to be subtracted from the transmission signal in advance, and the base station apparatus can perform precoding based on the information that has been fed back.

While according to the present embodiment the number of the mobile station apparatuses for spatial multiplexing is two, this is merely an example and it is also possible to spatially multiplex three or more mobile station apparatuses. In this case, a plurality of companion precoding vectors and a plurality of coefficients indicating the multi-user interference to be subtracted may be fed back, and the multi-user interference from the plurality of mobile station apparatuses may be subtracted from the transmission signal in advance. Alternatively, as in the present embodiment, a single companion precoding vector and a single coefficient indicating the multi-user interference to be subtracted may be fed back, and only the multi-user interference from one of the mobile station apparatuses may be subtracted from the transmission signal in advance.

Further, according to the present embodiment, the vector that minimizes the influence on one station is selected from the codebook as the companion precoding vector. However, this is merely an example, and a vector with the maximum influence other than the desired precoding vector may be selected from the codebook. Further, the interference coefficient to be subtracted may be a complex vector, and the complex interference vector may be selected from predetermined candidates and fed back. In this case, a precoding vector such that a complex interference vector which is the closest to one of the predetermined candidates can be obtained may be selected as the companion precoding vector.

When the interference to be subtracted is small to an extent, as in the first embodiment, the modulo arithmetic may not be performed. Namely, the modulo arithmetic may be turned on or off depending on the magnitude (power) of the interference signal to be subtracted. When no modulo arithmetic is performed in the base station apparatus, no modulo arithmetic may be performed in the mobile station apparatus.

### Third Embodiment

According to the second embodiment, the desired precoding vector fed back from each mobile station apparatus is used for precoding as is. However, even when implicit CSI feedback is performed according to the present invention, the precoding vector that has been fed back need not be used for precoding as is. Specifically, a new precoding vector may be generated in the base station apparatus on the basis of the information that has been fed back, and a linear filter may be generated on the basis of the new precoding vector. For example, a new precoding vector is generated depending on the situation in the configuration according to the first embodiment. However, as described above, in the configuration of the first embodiment, if there is an error between the complex conjugate transpose of the precoding vector that has been fed back and the actual propagation path, the multi-user interference cannot be appropriately removed, resulting in degradation of the reception performances.

Thus, according to the present embodiment, a configuration is described such that, when a new precoding vector is generated in the base station apparatus on the basis of the desired precoding vector fed back from each mobile station apparatus, the multi-user interference that each mobile station apparatus is subjected to is measured, and the result of the measurement is grasped by the base station apparatus so that the multi-user interference can be appropriately subtracted from the transmission signal.

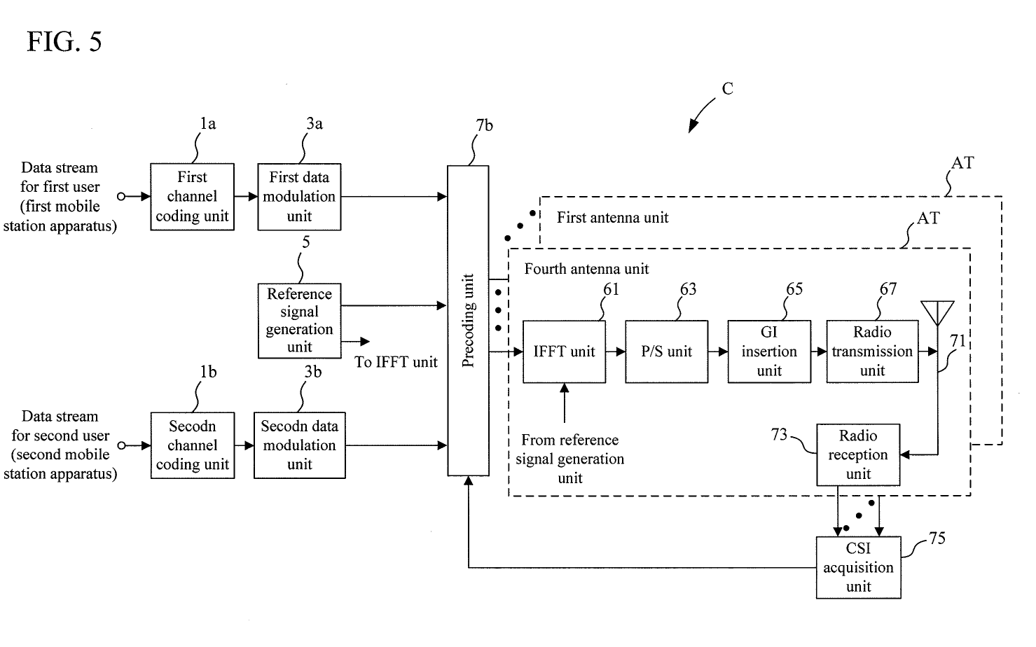

First, a configuration of the base station apparatus according to the present embodiment is shown in FIG. 5. The present embodiment is directed to a multi-carrier transmission system in which the number of the sub-carriers used is four, for example. The base station apparatus has four transmission antennas (Nₜ=4), and each of the two mobile station apparatuses (mobile station apparatuses 1 and 2) has one reception antenna.

As shown in FIG. 5, the base station apparatus according to the present embodiment is configured such that an IFFT (Inverse Fast Fourier Transform) unit 61, a P/S (Parallel to Serial conversion) unit 63, and a GI (Guard Interval) insertion unit 65 are added in each of the transmission antenna systems of the base station apparatus shown in FIG. 1. This is because the present embodiment is directed to a multi-carrier transmission system. In the IFFT unit 61, a process for converting a frequency domain signal into a time domain signal is performed, and, after parallel-serial conversion is performed in the P/S unit 63, a guard interval (a signal referred to as a “cyclic prefix”, which is a copy of a part of a symbol) is inserted in the GI insertion unit 65, whereby an actual transmission signal is generated. According to the present embodiment, since the number of the sub-carriers used is four, signals for the four sub-carriers are inputted to the IFFT unit 61 in parallel. Such processing is performed for each of the transmission antenna systems (first to fourth antennas).

Prior to the data signal MU-MIMO transmission, the base station apparatus transmits the reference signal for propagation path estimation, which is required for estimating the propagation path and selecting the desired precoding vector in each mobile station apparatus. Because the present embodiment is directed to multi-carrier transmission, the reference signal is transmitted by using sub-carriers which are orthogonal for the respective transmission antennas. For example, from the first antenna, a signal in which the reference signal is only allocated to the sub-carrier 1 is transmitted; from the second antenna, a signal in which the reference signal is only allocated to the sub-carrier 2 is transmitted. Similarly, from the third antenna, a signal in which the reference signal is allocated to only the sub-carrier 3 is transmitted, and from the fourth antenna, a signal in which the reference signal is allocated to only the sub-carrier 4 is transmitted. The reference signal is inputted from the reference signal generation unit to the IFFT unit and converted into a time domain signal therein. As described above, the nth antenna transmits the signal in which the reference signal is allocated to only the sub-carrier n. Thus, to the IFFT unit in the transmission system for the third antenna, for example, the signal in which the reference signal is allocated only to the sub-carrier 3, as in [0 0 1 0]^{T}, is inputted, where 1 is the known reference signal.

Thus, the base station apparatus transmits the reference signal which is orthogonal between the transmission antennas, and each mobile station apparatus receives the reference signal and performs propagation path estimation based on the received reference signal. The mobile station apparatuses each select the desired precoding vector on the basis of the result of propagation path estimation, and feed back the precoding vector to the base station apparatus as the CSI. According to the present embodiment, the propagation paths for the four sub-carriers are substantially the same (flat fading environment), and a single common precoding vector is selected by the sub-carriers and fed back. A configuration of the mobile station apparatus according to the present embodiment will be described later.

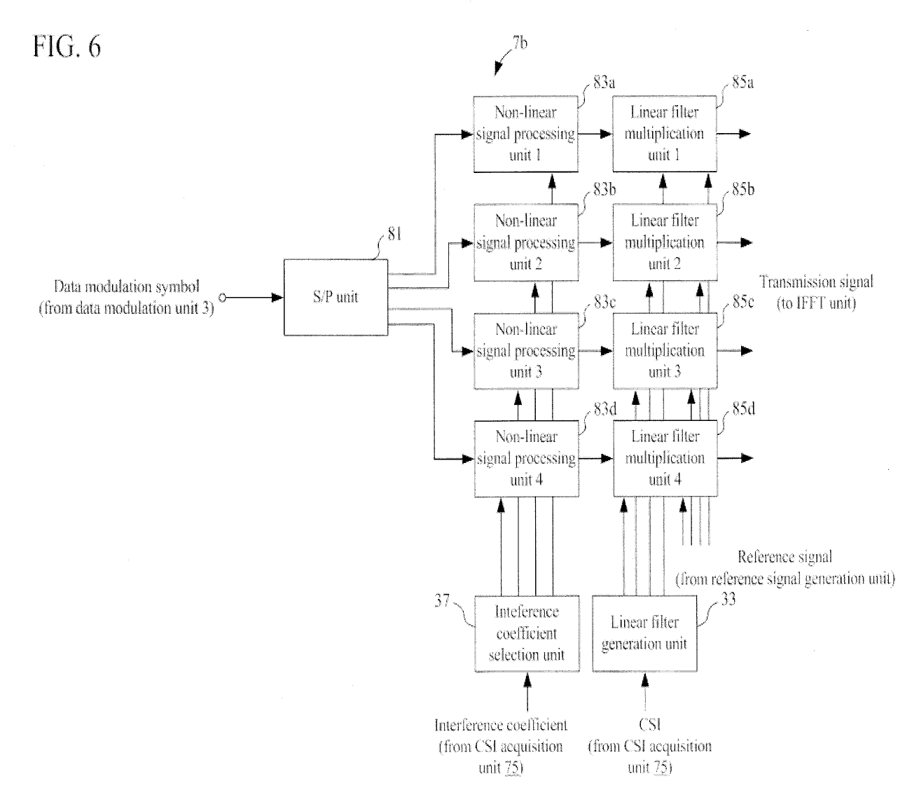

The CSI (precoding vector) fed back from each mobile station apparatus is acquired by the CSI acquisition unit 75 of the base station apparatus shown in FIG. 5 via the reception antenna 71 and the radio reception unit 73. The CSI is then inputted to the precoding unit 7b. FIG. 6 shows a configuration of the precoding unit 7b according to the present embodiment. As shown in FIG. 6, the precoding unit 7b according to the present embodiment includes an interference coefficient selection unit 37, a linear filter generation unit 33, a S/P (Serial to Parallel conversion) unit 81, non-linear signal processing units (1 to 4) 83a to 83d, and linear filter multiplication units (1 to 4) 85a to 85d. Unlike the configuration of FIG. 2 or 4, the precoding unit 7b according to the present embodiment is provided with four non-linear signal processing units 83 and four linear filter multiplication units 85. This is because the present embodiment is directed to a multi-carrier transmission system using four sub-carriers in which the respective non-linear signal processing units 83a to 83d and linear filter multiplication units 85a to 85d perform signal processing for each sub-carrier. Namely, the non-linear signal processing unit (1) 83a and the linear filter multiplication unit (1) 85a perform the signal processing for a first sub-carrier; the non-linear signal processing unit (2) 83b and the linear filter multiplication unit (2) 85b perform the signal processing for a second sub-carrier; the non-linear signal processing unit (3) 83c and the linear filter multiplication unit (3) 85c perform the signal processing for a third sub-carrier; and the non-linear signal processing unit (4) 83d and the linear filter multiplication unit (4) 85d perform the signal processing for a fourth sub-carrier. In FIG. 6, as many non-linear signal processing units and linear filter multiplication units as there are the sub-carriers are provided. However, this is for ease of description, and there may not necessarily be the same number of process units as the number of sub-carriers as long as an arithmetic is performed on a sub-carrier basis.

To the linear filter generation unit 33 of the precoding unit 7b, the CSI fed back from each mobile station apparatus is inputted from the CSI acquisition unit 21. The CSI is the precoding vector selected from the codebook according to expression (6), for example, as in the first and second embodiments. For example, the linear filter generation unit 33 generates a new precoding vector on the basis of the inputted precoding vector. The precoding vector may be generated by several methods. In the following, a method according to a SLNR (Signal to Leakage plus Noise power Ratio) criterion will be described. The precoding vector generated according to the SLNR criterion is a vector that maximizes the ratio of the reception power for the desired signal in each mobile station apparatus to the sum of the power of multi-user interference given to the other mobile station apparatus and the noise power in the other mobile station apparatus. For example, the precoding vector w₁ by which the transmission signal addressed to the mobile station apparatus 1 is multiplied is given by the following expression.

$$\begin{matrix}{w}_{1} = {arg max}_{w} \frac{{w}^{H} {H}_{1}^{H} {H}_{1} w}{{w}^{H} ( {H}_{2}^{H} {H}_{2} + {σ}_{1}^{2} I ) w} \\ = evec \{ {( {R}_{2} + {σ}_{1}^{2} I )}^{- 1} {R}_{1} \}\end{matrix} \qquad ( 19 )$$

In the above, Hᵤ indicates the propagation path for the mobile station apparatus u, and σᵤ² indicates the inverse of the SINR (reception quality) in the mobile station apparatus u. The σᵤ² is also a value measured in each mobile station apparatus and fed back to the base station apparatus. Rᵤ can be approximated by a covariance matrix of the desired precoding vector fed back from the mobile station apparatus u. For example, when the precoding vector that has been fed back is pᵤ, Rᵤ≈pᵤpᵤ^{H}. Thus, by using the precoding vector pᵤ fed back from each mobile station apparatus and expression (19), it becomes possible to generate the new precoding vector wᵤ. The evec(x) represents an eigenvector of x. In the present example, the number of the reception antennas in each mobile station apparatus is one and transmission of rank 1 is performed, so that an eigenvector corresponding to the maximum eigenvalue is extracted as the precoding vector wᵤ When such precoding vector is generated with respect to the mobile station apparatus 2, the subscripts (1, 2) in expression (19) may be entirely replaced. The linear filter generation unit generates the new precoding vector wᵤ (u=1, 2) according to such arithmetic, and outputs [w₁ w₂] to the linear filter multiplication units (1) to (4) as a linear filter. Since the present embodiment is directed to a flat fading environment, all of the sub-carriers are multiplied by the same linear filter.

According to the present embodiment, when the data signal addressed to each mobile station apparatus is multiplied by the linear filter [w₁ w₂] generated as described above and MU-MIMO transmission is performed, each mobile station apparatus needs to measure the coefficient representing the interference to which each mobile station apparatus is subjected to so as to subtract the multi-user interference from the transmission signal. Thus, the base station apparatus transmits a known reference signal multiplied by the linear filter, and each mobile station apparatus performs propagation path estimation using the reference signal and acquires the coefficient representing the multi-user interference. For this purpose, the linear filter [w₁ w₂] and the reference signal are inputted to the linear filter multiplication unit and multiplied. The reference signal multiplied by the linear filter is outputted from the precoding unit and transmitted via the IFFT unit and the like. It should be noted that in order for each mobile station apparatus to measure the coefficient indicating the multi-user interference correctly, the transmitted reference signal needs to be orthogonal. Thus, according to the present embodiment, the reference signal which is orthogonal between the sub-carriers is transmitted.

A specific example will be described below. First, let w₁=[w₁₁ w₁₂ w₁₃ w₁₄]^{T}, w₂=[w₂₁ w₂₂ w₂₃ w₂₄]^{T} and let the reference signal be “1” for simplicity. Then, the linear filter multiplication units 1 and 3 multiply [w₁ w₂] and [1 0]^{T}, while the linear filter multiplication units 2 and 4 multiply [w₁ w₂] and [0 1]^{T}. As a result, the linear filter multiplication units 1 and 3 obtain w₁, and the linear filter multiplication units 2 and 4 obtain w₂, which are outputted from the precoding unit 7b and inputted to the IFFT unit 61. In this case, of the output from the linear filter multiplication unit (1)85a, i.e., w₁[w₁₁ w₁₂ w₁₃ w₁₄]^{T}, w₁₁ is allocated to the sub-carrier 1 for the first antenna; w₁₂ is allocated to the sub-carrier 1 for the second antenna; w₁₃ is allocated to the sub-carrier 1 for the third antenna; and w₁₄ is allocated to the sub-carrier 1 for the fourth antenna. Of the output from the linear filter multiplication unit (2) 85b, namely w₂=[w₂₁ w₂₂ w₂₃ w₂₄]^{T}, w₂₁ is allocated to the sub-carrier 2 for the first antenna; w₂₂ is allocated to the sub-carrier 2 for the second antenna; w₂₃ is allocated to the sub-carrier 2 for the third antenna; and w₂₄ is allocated to the sub-carrier 2 for the fourth antenna. Further, of the output from the linear filter multiplication unit (3) 85c, w₁₁ is allocated to the sub-carrier 3 for the first antenna; w₁₂ is allocated to the sub-carrier 3 for the second antenna; w₁₃ is allocated to the sub-carrier 3 for the third antenna; and w₁₄ is allocated to the sub-carrier 3 for the fourth antenna. Of the output from the linear filter multiplication unit (4) 85d, w₂₁ is allocated to the sub-carrier 4 for the first antenna; w₂₂ is allocated to the sub-carrier 4 for the second antenna; w₂₃ is allocated to the sub-carrier 4 for the third antenna; and w₂₄ is allocated to the sub-carrier 4 for the fourth antenna. Thus, to the IFFT unit 61 for the first antenna, for example, the reference signal [w₁₁ w₂₁ w₁₁ w_{21]}^{T} is inputted.

The reference signal thus generated is transmitted from the base station and then received by each mobile station apparatus. The reference signal received by each mobile station apparatus will be represented by the following expression, where the numbers in the parentheses of the subscripts indicate the sub-carrier number, with expression (20) representing the reception reference signal for the sub-carrier 1 and expression (21) representing the reception reference signal for the sub-carrier 2. For simplicity's sake, a noise component is disregarded.

$$\begin{matrix}\begin{matrix}( \begin{matrix}{r}_{p 1 ( 1 )} \\ {r}_{p 2 ( 1 )}\end{matrix} ) = ( \begin{matrix}{H}_{1} \\ {H}_{2}\end{matrix} ) {w}_{1} \\ = ( \begin{matrix}a \\ b\end{matrix} )\end{matrix} & ( 20 ) \\ \begin{matrix}( \begin{matrix}{r}_{p 1 ( 2 )} \\ {r}_{p 2 ( 2 )}\end{matrix} ) = ( \begin{matrix}{H}_{1} \\ {H}_{2}\end{matrix} ) {w}_{2} \\ = ( \begin{matrix}c \\ d\end{matrix} )\end{matrix} & ( 21 )\end{matrix}$$

According to the present embodiment, the reception reference signal for the sub-carrier 3 is the same as for the sub-carrier 1, and the reception reference signal for the sub-carrier 4 is the same as for the sub-carrier 4, so that these reception reference signals are omitted. Thus, the same reception reference signals are obtained for a plurality of sub-carriers, so that it may be said that there is no need to transmit the reference signal for the sub-carriers 3 and 4.

From the reference signal multiplied by the transmit filter, the values of (a, c) and (b, d) in the above expression for the mobile station apparatus 1 and the mobile station apparatus 2, respectively, can be measured. Of these values, a and d indicate the values for the equivalent propagation path by which the desired signal is multiplied, while b and c indicate the values for the equivalent propagation path by which the multi-user interference is multiplied. Thus, in order to subtract the multi-user interference from the transmission signal in the base station apparatus, each mobile station apparatus feeds back these values as the interference coefficient. According to the present embodiment, a value obtained by dividing the value for the equivalent propagation path for multiplication of the multi-user interference by the value for the equivalent propagation path for multiplication of the desired signal is fed back. Namely, the mobile station apparatus 1 feeds back c/a and the mobile station apparatus 1 feeds back d/b to the base station apparatus. In practice, the values are quantized for feedback. A plurality of values as the interference coefficient candidates may be prepared in advance, and an index and the like indicating the candidate value which is the closest to the calculated interference coefficient may be fed back.

The interference coefficient fed back from each mobile station apparatus is acquired by the CSI acquisition unit 21 in the same way for the CSI, and then inputted to the interference coefficient selection unit 37 of the precoding unit 7b. The interference coefficient selection unit 37 determines the multi-user interference for which mobile station apparatus should be subtracted, as in the second embodiment. In the present example, the interference coefficient that has been fed back with the greater absolute value is selected for subtraction. Thus, when the interference the signal addressed to the mobile station apparatus 2 has on the reception signal in the mobile station apparatus 1 is to be subtracted in advance, the interference coefficient selection unit 37 outputs c/a to the non-linear signal processing units (1) 83a to (4) 83d. Conversely, when the interference that the signal addressed to the mobile station apparatus 1 has on the reception signal in the mobile station apparatus 2 is to be subtracted in advance, the interference coefficient selection unit 37 outputs d/b to the non-linear signal processing units (1) 83a to (4) 83d.

To the non-linear signal processing unit (1) 83a to (4) 83d, in addition to the interference coefficients, the data modulation signal that has passed through the S/P unit 81 is inputted. Then, a process for subtracting the multi-user interference from the desired modulation signal addressed to one or the other mobile station apparatus is performed. For example, when the data modulation signal dᵤₙ addressed to the mobile station apparatus u is inputted to the non-linear signal processing unit n, and the interference that the signal addressed to the mobile station apparatus 2 has on the reception signal in the mobile station apparatus 1 is to be subtracted in advance, the non-linear signal processing unit n subtracts the multi-user interference by the following expression to obtain a transmission signal x₁ₙ. To the mobile station apparatus 2, d₂ₙ is transmitted as is.

$${x}_{1 n} = {d}_{1 n} - \frac{c}{a} {d}_{2 n} \qquad ( 22 )$$

While the multi-user interference that the mobile station apparatus 1 is subjected to can be removed by the above subtracting process, the signal amplitude may be increased and excessive transmission power may be required as a result of the subtracting process. Thus, as in the preceding embodiments, the non-linear signal processing units (1) 83a to (4) 83d subject the transmission signal for which interference subtraction has been performed (the signal according to expression (22) addressed to the mobile station apparatus 1) to the non-linear signal processing, referred to as the modulo arithmetic, according to expression (14). The signal [x₁ₙ d₂ₙ] addressed to the two mobile station apparatuses is inputted from the non-linear signal processing unit 83 to the linear filter multiplication unit 85. The linear filter multiplication unit performs multiplication with the linear filter [w₁ w₂] and the result is outputted from the precoding unit. It should be noted that the component in the first line of the vectors obtained by the multiplication of the linear filter and the transmission signal (the vectors obtained by the respective linear filter multiplication units 85a to 85d) is outputted such that the component is allocated to the sub-carriers for the first antenna. Similarly, the component in the second line of the vectors is outputted such that the component is allocated to the sub-carriers for the second antenna; the component in the third line of the vectors is outputted such that the component is allocated to the sub-carriers for the third antenna; and the component in the fourth line of the vectors is outputted such that the component is allocated to the sub-carriers for the fourth antenna.

After the multi-user interference is subtracted from the transmission signal in advance and then the modulo arithmetic is performed, the signal multiplied by the linear filter is outputted from the precoding unit 7b and transmitted from the respective antennas 71 via the IFFT unit 61 and the like required for the multi-carrier transmission system. Also, the reference signal as the criterion for demodulation of the transmitted data signal is transmitted. The reference signal for demodulation is processed in the same way as for the reference signal for interference coefficient measurement and then transmitted. By adopting the configuration of the base station apparatus as described above, when a new precoding vector is generated by the base station apparatus, the multi-user interference that each mobile station apparatus is subjected to can be measured and the result of measurement can be grasped by the base station apparatus. Thus, the multi-user interference can be appropriately subtracted from the transmission signal.

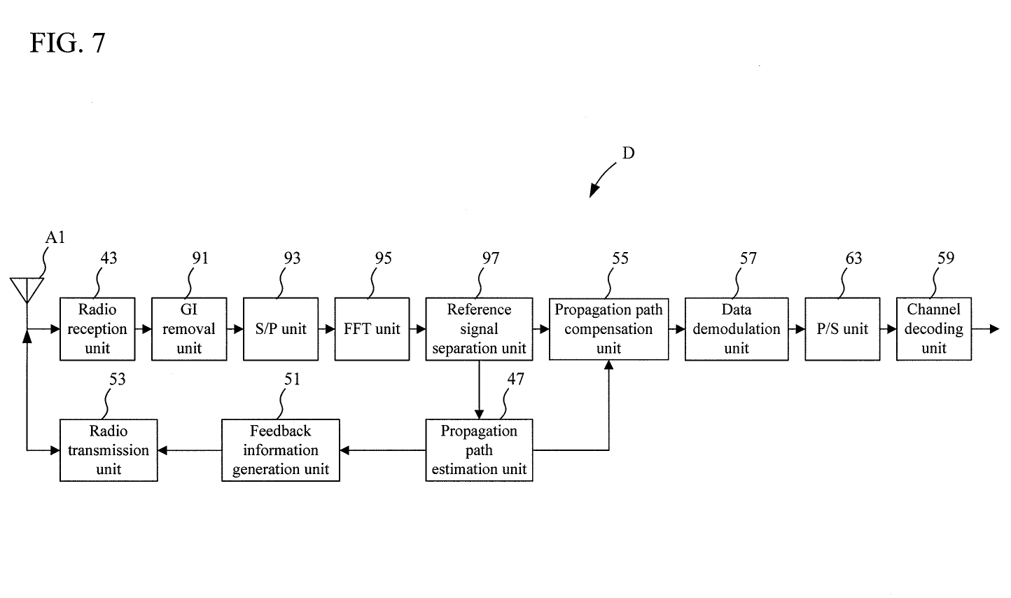

FIG. 7 shows a configuration of the mobile station apparatus according to the present embodiment. As shown in FIG. 7, because the present embodiment is directed to multi-carrier transmission, a mobile station apparatus D is provided with a GI removal unit 91, a FFT unit 95, a S/P unit 93, and the P/S unit 63, which are required for a multi-carrier transmission system. The FFT unit 95 converts a time domain reception signal into a frequency domain signal, and propagation path compensation and demodulation are performed on a sub-carrier basis. The mobile station apparatus D according to the present embodiment requires propagation path estimation for selecting the desired precoding vector, estimation (measurement) of the coefficient indicating the multi-user interference, and propagation path estimation for data signal demodulation, as described above. The mobile station apparatus D shown in FIG. 7 perform all of these estimations in the propagation path estimation unit 47. On the basis of the estimated information, the feedback information generation unit 51 selects the desired precoding vector and calculates the interference coefficient for feedback (values such as c/a and d/b), and these information are fed back to the base station apparatus. The desired precoding vector is selected by the same method as in the first and second embodiments. By adopting the above configuration of the mobile station apparatus, when a new precoding vector is generated by the base station apparatus, the multi-user interference that each mobile station apparatus is subjected to can be measured, and the base station apparatus can be informed about the result of measurement, so that the data signal in which the multi-user interference is appropriately subtracted from the transmission signal can be received.

By adopting the configuration of the base station apparatus and the mobile station apparatus as described above, when a new precoding vector is generated by the base station apparatus on the basis of the information about the desired precoding vector fed back from each mobile station apparatus, and when spatial multiplexing is performed by using the linear filter based on the newly generated precoding vector, a coefficient representing the multi-user interference that each mobile station apparatus is subjected to is measured and the base station apparatus is informed about the result of measurement, whereby the multi-user interference can be appropriately subtracted from the transmission signal, and improved reception characteristics can be obtained.

In this case, the base station apparatus transmits the reference signal necessary for allowing the mobile station apparatus to select the desired precoding vector and the reference signal necessary for measuring the coefficient representing the multi-user interference. These reference signals differ from each other in that the latter is a signal multiplied by the linear filter (the aforementioned [w₁ w₂]), whereas the former is not subjected to such processing. Thus, their transmission may be performed at independent timings. For example, the reference signal for allowing the mobile station apparatus D to select the desired precoding vector may be periodically transmitted only once every several frames. The reference signal for interference coefficient measurement may be transmitted for every frame after the linear filter ([w₁ w₂]) is generated, whereby the user interference can be removed appropriately in accordance with the variation in propagation path. The reference signal for interference coefficient measurement may be transmitted only when the desired reception performances cannot be obtained in the mobile station apparatus and a bit error is caused (i.e., a signal requesting retransmission is returned). In such a case, on the basis of the interference coefficient measured by using the reference signal, the multi-user interference may be subtracted from the transmission signal addressed to the mobile station apparatus in which the desired reception performances cannot be obtained, whereby the reception performances of the particular mobile station apparatus can be improved. Further, in this case, the interference coefficient may be fed back only from the mobile station apparatus in which the desired reception performances cannot be obtained.

Further, while according to the present embodiment the precoding vector according to the SLNR criterion is generated, this is merely an example and the present embodiment may be applied to a system in which, when codebook-based feedback is performed, a new precoding vector is generated on the basis of the information that has been fed back.

Further, for the precoding vector for the transmission signal addressed to a mobile station apparatus, the desired precoding vector fed back from the mobile station apparatus D may be used as is. For example, for the precoding vector by which the transmission signal addressed to the mobile station apparatus 1 is multiplied, p₁ that has been fed back is used as is, while the precoding vector by which the transmission signal addressed to the mobile station apparatus 2 is multiplied is calculated according to expression (19). Thus, the linear filter by which the transmission signal is multiplied in the linear filter multiplication unit is [p₁ w₂]. When spatial multiplexing is performed by using such a linear filter, the transmission signal addressed to the mobile station apparatus 2 is multiplied by w₂ according to the SLNR criterion, so that the multi-user interference that the mobile station apparatus 1 is subjected to tends not to be so large. However, the transmission signal addressed to the mobile station apparatus 1 is multiplied by p₁ that does not take the other mobile station apparatus into consideration at all, so that the multi-user interference that the mobile station apparatus 2 is subjected to may become very large. Accordingly, in such a case, it is preferable to measure the interference coefficient in the mobile station apparatus 2 and feed back the measured interference coefficient so that the multi-user interference can be subtracted from the transmission signal addressed to the mobile station apparatus 2 in the base station apparatus. Further, in this case, there is no need to send the reference signal for interference coefficient measurement, and the mobile station apparatus 2 may only be informed of the index for the precoding vector p₁ used by the mobile station apparatus 1. This is because the precoding vector pᵤ is a vector included in the common codebook for the transmitting and receiving parties, so that the mobile station apparatus 2 can grasp the concrete pᵤ by simply being notified of the index, and the coefficient representing the multi-user interference can be calculated by Hᵤ×pᵤ, as in the second embodiment.

By the above configuration, favorable reception characteristics may be obtained compared with the method by which the precoding vector for all of the mobile station apparatuses is calculated by the SLNR criterion. Further, the need for transmitting the reference signal necessary for measuring the interference coefficient can be eliminated, whereby the transmission efficiency is thought to be improved.

While the present embodiment has been described with reference to spatial multiplexing for two mobile station apparatuses, this is merely an example and three or more mobile station apparatuses may be used. In such cases, the precoding vector according to the SLNR criterion can be calculated according to the following expression.

$${w}_{k} = evec \{ {( {\sum }_{u \neq k} {R}_{u} + {σ}_{k}^{2} I )}^{- 1} {R}_{k} \} \qquad ( 23 )$$

For example, when spatial multiplexing for four mobile station apparatuses is performed, the reception signal in each mobile station apparatus can be represented by the following expression, where dᵤ is the transmission signal addressed to the mobile station apparatus u and h_{eq} is the equivalent propagation path. For simplicity, a noise component is disregarded.

$$\begin{matrix}( \begin{matrix}{r}_{1} \\ {r}_{2} \\ {r}_{3} \\ {r}_{4}\end{matrix} ) = ( \begin{matrix}{H}_{1} \\ {H}_{2} \\ {H}_{3} \\ {H}_{4}\end{matrix} ) ( \begin{matrix}{w}_{1} & {w}_{2} & {w}_{3} & {w}_{4}\end{matrix} ) ( \begin{matrix}{d}_{1} \\ {d}_{2} \\ {d}_{3} \\ {d}_{4}\end{matrix} ) \\ = ( \begin{matrix}{h}_{eq 11} & {h}_{eq 12} & {h}_{eq 13} & {h}_{eq 14} \\ {h}_{eq 21} & {h}_{eq 22} & {h}_{eq 23} & {h}_{eq 24} \\ {h}_{eq 31} & {h}_{eq 32} & {h}_{eq 33} & {h}_{eq 34} \\ {h}_{eq 41} & {h}_{eq 42} & {h}_{eq 43} & {h}_{eq 44}\end{matrix} ) ( \begin{matrix}{d}_{1} \\ {d}_{2} \\ {d}_{3} \\ {d}_{4}\end{matrix} )\end{matrix} \qquad ( 24 )$$

In expression (24), the diagonal components of the matrix with the components h_{eq} each represent an equivalent propagation path by which a desired signal is multiplied, while the off-diagonal components represent the equivalent propagation path by which the multi-user interference is multiplied. Thus, in this case, in order to subtract all of the multi-user interference, each mobile station apparatus needs to feed back three values as the interference coefficient to the base station apparatus because each row of the matrix contains three components representing the multi-user interference. Further, in this case, information about the multi-user interference from which mobile station apparatus is represented by each interference coefficient is also fed back. However, in this configuration, the amount of information that is fed back is increased as the number of the spatially multiplexed mobile station apparatuses is increased. Thus, the base station apparatus may be informed of only those of the interferences whose influence is particularly large, so that the interferences can be removed by the base station.

Further, while the present embodiment employs the reference signal which is orthogonal in the frequency domain, this is merely an example and the propagation path estimation and the interference coefficient measurement may be performed by using a reference signal which is orthogonal in the time domain. While the present embodiment performs precoding commonly for the four sub-carriers, the units in which the precoding is performed are not limited to this. However, the interference coefficient needs to be measured on the precoding unit basis.

A program that operates in the mobile station apparatus and the base station apparatus according to the present invention is a program for controlling a CPU and the like (program for causing a computer to function) so as to implement the functions of the foregoing embodiments according to the present invention. Information handled by such apparatuses are stored temporarily in a RAM during a process, and stored in various types of a ROM or a HDD that the CPU reads, corrects, or writes as need. The program may be stored in a recording medium such as a semiconductor medium (such as a ROM or a non-volatile memory card), an optical recording medium (such as a DVD, an MO, an MD, a CD, or a BD), or a magnetic recording medium (such as a magnetic tape, or a flexible disc). Not only the functions of the foregoing embodiments may be implemented by executing the program that is loaded, but also the functions of the present invention may be implemented by a process executed in cooperation with an operating system or another application program and the like on the basis of an instruction from the program.

When circulated in the marketplace, the program may be stored in a portable recording medium or transferred to a server computer connected via a network, such as the Internet. In this case, the storage apparatus in the server computer is also included in the present invention. A part or all of the mobile station apparatus and the base station apparatus according to the foregoing embodiments may be implemented as an LSI which typically takes the form of an integrated circuit. The functional blocks of the mobile station apparatus and the base station apparatus may be implemented as individual processors, or a part or all of the functional blocks may be integrated into a processor. The integrated circuit is not limited to an LSI but may include a dedicated circuit or a general-purpose processor. When integrated circuit technology that supplants the LSI is available as a result of developments in semiconductor technology, an integrated circuit by the replacing technology may be used.

While the embodiments of the present invention have been described with reference to the drawings, specific configurations are not limited to the embodiments, and designs and the like within the gist of the present invention are also included in the scope of the claims.

### INDUSTRIAL APPLICABILITY

The present invention can be utilized for a communication apparatus.

### REFERENCE SIGNS LIST

A Base station apparatus
AT Antenna unit
1a, 1b Channel coding unit
3 Data modulation unit
5 Reference signal generation unit
7 Precoding unit
11 Radio transmission unit
15 Antenna
17 Radio reception unit
21 CSI acquisition unit
31 Non-linear signal processing unit
33 Linear filter generation unit
35 Linear filter multiplication unit
37 Interference coefficient selection unit
43 Radio reception unit
45 Reference signal separating unit
47 Transmission path estimation unit
51 Feedback information generation unit
55 Transmission path compensation unit
57 Data demodulation unit
59 Channel decoding unit
61 IFFT unit
63 P/S unit
65 GI insertion unit
67 Radio transmission unit
71 Antenna
73 Radio reception unit
75 CSI acquisition unit
81 S/P unit
83a to 83d Non-linear signal processing unit
85a to 85d Linear filter multiplication unit
91 GI removal unit
93 S/P unit
95 FFT unit
97 Reference signal separating unit

All of the publications, patents, and patent applications cited in the description are incorporated herein by reference.

1. A radio communication system in which a base station apparatus with a plurality of transmission antennas spatially multiplexes and transmits a transmission signal addressed to a plurality of mobile station apparatuses, and in which the mobile station apparatuses receive the signal transmitted from the base station apparatus,
wherein:
the mobile station apparatuses select a desired precoding vector from predetermined candidates, and give the base station apparatus information identifying the selected precoding vector; and
the base station apparatus generates a linear filter on the basis of the information from the mobile station apparatuses, grasps multi-user interference that at least one of the mobile station apparatuses is subjected to when the generated linear filter is used, generates a new transmission signal by subtracting the multi-user interference from the transmission signal, and spatially multiplexes the transmission signal addressed to the plurality of mobile station apparatuses by multiplying the new transmission signal by the linear filter.

2. The radio communication system according to claim 1, wherein at least one of the plurality of mobile station apparatuses gives the base station apparatus information identifying a precoding vector different from the desired precoding vector.

3. The radio communication system according to claim 1, wherein at least one of the plurality of mobile station apparatuses measures a coefficient representing interference that the mobile station apparatus is subjected to, and informs the base station apparatus of the measured coefficient.

4. The radio communication system according to claim 1, wherein the new transmission signal is generated by performing a modulo arithmetic after the multi-user interference is subtracted from the transmission signal.

5. A base station apparatus in a radio communication system in which a base station apparatus with a plurality of transmission antennas spatially multiplexes and transmits a transmission signal addressed to a plurality of mobile station apparatuses, and in which the mobile station apparatuses receive the signal transmitted from the base station apparatus,
wherein the base station apparatus acquires information identifying a desired precoding vector selected by the mobile station apparatuses from predetermined candidates, generates a linear filter on the basis of the acquired information, grasps multi-user interference that at least one of the mobile station apparatuses is subjected to when the generated linear filter is used, generates a new transmission signal by subtracting the multi-user interference from the transmission signal, and spatially multiplexes the transmission signal addressed to the plurality of mobile station apparatuses by multiplying the new transmission signal by the linear filter.

6. A mobile station apparatus in a radio communication system in which a base station apparatus with a plurality of transmission antennas spatially multiplexes and transmits a transmission signal addressed to a plurality of mobile station apparatuses, and in which the mobile station apparatuses receive the signal transmitted from the base station apparatus,
wherein the mobile station apparatus selects a desired precoding vector from predetermined candidates, gives the base station apparatus information identifying the selected precoding vector, and receives a new transmission signal generated by subtracting multi-user interference from the transmission signal in the base station apparatus.

7. The mobile station apparatus according to claim 6, wherein the mobile station apparatus informs the base station apparatus of information identifying a precoding vector different from the desired precoding vector.

8. The mobile station apparatus according to claim 6, wherein the mobile station apparatus measures a coefficient representing interference that the mobile station apparatus is subjected to, and informs the base station apparatus is informed of the measured coefficient.

9. The radio communication system according to claim 2, wherein at least one of the plurality of mobile station apparatuses measures a coefficient representing interference that the mobile station apparatus is subjected to, and informs the base station apparatus of the measured coefficient.

10. The radio communication system according to claim 2, wherein the new transmission signal is generated by performing a modulo arithmetic after the multi-user interference is subtracted from the transmission signal.

11. The mobile station apparatus according to claim 7, wherein the mobile station apparatus measures a coefficient representing interference that the mobile station apparatus is subjected to, and informs the base station apparatus of the measured coefficient.
